(19) United States
(12) Patent Application Publication
(10) Pub. No.: US 2025/0340967 A1
(43) Pub. Date: Nov. 6, 2025

(54) INTENSIFIED SEQUENTIAL RECOVERY OF RARE EARTH ELEMENTS AND OTHER CRITICAL METALS FROM WASTE

(71) Applicant: Georgia Tech Research Corporation, Atlanta, GA (US)

(72) Inventors: Yuanzhi Tang, Atlanta, GA (US); Yinghao Wen, Atlanta, GA (US)

(21) Appl. No.: 19/198,361

(22) Filed: May 5, 2025

Related U.S. Application Data
(60) Provisional application No. 63/642,353, filed on May 3, 2024.

(51) Int. Cl. C22B 3/46; C22B 3/02; C22B 3/16; C22B 3/22; C22B 59/00

(52) U.S. Cl. CPC C22B 3/46; C22B 3/02; C22B 3/165; C22B 3/22; C22B 59/00

(57) ABSTRACT

Disclosed herein are systems and methods for enhancing metal recovery and/or processing from a waste source.

### CROSS REFERENCE TO RELATED APPLICATION

This application claims priority to, and the benefit of, U.S. Provisional Patent Application No. 63/642,353 filed May 3, 2024, which is incorporated by reference herein in its entirety.

### GOVERNMENT LICENSE RIGHTS

This invention was made with government support under DE-AR0001394 awarded by the U.S. Department of Energy. The government has certain rights in the invention.

### BACKGROUND

Rare earth elements (REE) are the building blocks of many clean energy technologies (e.g., hybrid/electric vehicles, wind turbines, and photovoltaics) and play a pivotal role in the transition into a net-zero economy. Due to rapidly increasing demand for REE and the vulnerable global supply chain from mining, recovery of REE from alternative sources has received considerable interest. Alternative waste feedstocks such as mine tailing, coal fly ash (CFA), and MSWIA have been recently recognized as promising sources for REE. The U.S. alone produces ˜70 million tons of CFA and ˜10 million tons of MSWIA annually, yet most of them are landfilled with barely any recycling or reuse. The low utilization rate and heavy disposal of these waste residues pose serious management costs and environmental hazards. CFA and MSWIA contain an appreciable amount of REE (˜200-800 ppm of total REE) as well as many other valuable metals (e.g., Al, Fe, Cu, Zn, Mn, Co, Ni). Considering the massive production of these solid wastes, the overall economic and environmental benefits of a viable technology that can recover multiple valuable metals can be significant.

Thus, there are benefits to improving industrial processes that produce or consume waste materials including waste ash as well as mining residues.

### SUMMARY

In various aspects, disclosed herein is a method for enhancing metal recovery and/or processing from a waste source. The methods can include: receiving a pre-concentrated feedstock, wherein the pre-concentrated feedstock comprises a leachate of a waste material contacted with a chelating agent (e.g., an organic ligand) that has been subjected to a eutectic freeze crystallization (EFC) process; and selectively removing one or more target metals from the pre-concentrated feedstock by contacting the pre-concentrated feedstock with a precipitation agent (e.g., one or more precipitation agents) to form a solid precipitate comprising at least one of the one or more target metal, and separating the solid precipitate from the pre-concentrated feedstock.

In some aspects, the waste source comprises coal fly ash (CFA), municipal solid waste incineration ash (MSWIA), industrial solid waste incineration ash, mine tailings, or a combination thereof.

In some aspects, selectively recovering the one or more target metals from the pre-concentrated feedstock comprises a sulfide precipitation, an alkaline precipitation, and/or an oxalate precipitation.

In some aspects, the method further includes performing sequential precipitations using a plurality of precipitation agents to selectively remove a plurality of target metals.

In some aspects, the method further includes: predicting, via thermodynamic modeling, interactions between the plurality of target metals, the plurality of precipitation agents, and/or the chelating agent, to determine parameters (e.g., an order) of the sequential precipitations to optimize metal recovery.

In some aspects, the one or more target metals comprise a rare earth element (REE).

In some aspects, the one or more target metals comprise Mg, Al, Ca, Fe, Cu, Zn, Ni, Co, Y, La, Ce, Pr, Nd, Gd, Dy, or a combination thereof.

In some aspects, a concentration factor of the one or more target metals in the pre-concentrated feedstock is 5.0 or more (e.g., 5.5 or more, 6.0 or more, 6.5 or more, 7.0 or more, 7.5 or more, or 8.0 or more).

In some aspects, an overall recovery of the one or more target metals is 75% or more (e.g., 80% or more, 85% or more, 90% or more, 95% or more, 97% or more, 99% or more).

In some aspects, an enrichment factor of the one or more target metals compared to the waste material is 2.5 or more (e.g., 5 or more, 10 or more, 15 or more, 20 or more, 25 or more, 30 or more, 35 or more, or 40 or more).

In some aspects, the chelating agent comprises citric acid or a salt thereof.

In some aspects, the method also includes substantially separating a purified metal product from the solid precipitate.

In some aspects, the method includes subjecting a residual stream of the pre-concentrated feedstock following removal of the one or more target metals to a post-treatment step to process undesired metal materials.

In some aspects, the post treatment step comprises a hydrothermal treatment process to form zeolites.

Also described herein is a method for enhancing metal recovery and/or processing from a waste source, comprising: contacting a waste source containing one or more target metals (e.g., a waste ash) with a chelating agent (e.g., an organic ligand) to form a leachate; subjecting the leachate to a eutectic freeze crystallization (EFC) process to concentrate the one or more target metals in a concentrated feedstock; wherein the concentrated feedstock is subsequently contacted with a precipitation agent (e.g., one or more precipitation agents) to selectively remove the one or more target metals from the concentrated feedstock and form a solid precipitate comprising at least one of the one or more target metal.

In some aspects, the waste source comprises coal fly ash (CFA), municipal solid waste incineration ash (MSWIA), industrial solid waste incineration ash, mine tailings, or a combination thereof.

In some aspects, selectively recovering the one or more target metals from the concentrated feedstock comprises a sulfide precipitation, an alkaline precipitation, and/or an oxalate precipitation.

In some aspects, the method also includes performing sequential precipitations using a plurality of precipitation agents to selectively remove a plurality of target metals.

In some aspects, the one or more target metals comprise a rare earth element (REE).

In some aspects, the one or more target metals comprise Mg, Al, Ca, Fe, Cu, Zn, Ni, Co, Y, La, Ce, Pr, Nd, Gd, Dy, or a combination thereof.

In some aspects, a concentration factor of the one or more target metals in the concentrated feedstock is 5.0 or more (e.g., 5.5 or more, 6.0 or more, 6.5 or more, 7.0 or more, 7.5 or more, or 8.0 or more).

In some aspects, an overall recovery of the one or more target metals is 75% or more (e.g., 80% or more, 85% or more, 90% or more, 95% or more, 97% or more, 99% or more).

In some aspects, an enrichment factor of the one or more target metals compared to the waste source is 2.5 or more (e.g., 5 or more, 10 or more, 15 or more, 20 or more, 25 or more, 30 or more, 35 or more, or 40 or more).

In some aspects, the chelating agent comprises citric acid or a salt thereof.

In another aspect, disclosed herein is a method for enhancing metal recovery and/or processing from a waste source, comprising: contacting a waste source (e.g., a waste ash) containing a plurality of target metals with a chelating agent (e.g., an organic ligand) to form a leachate; subjecting the leachate to a eutectic freeze crystallization (EFC) process to concentrate the plurality of target metals in a concentrated feedstock; contacting the concentrated feedstock with a sulfide precipitation agent to selectively form a first precipitate comprising an insoluble metal-sulfide complex, and a residual mixture; separating the first precipitate from the residual mixture; contacting the residual mixture with an alkaline precipitation agent to selectively form a second precipitate comprising an insoluble metal-hydroxide, and a second residual mixture; separating the second precipitate from the second residual mixture; contacting the second residual mixture with an oxalate precipitation agent to selectively form a third precipitate comprising an insoluble metal-oxalate complex, and a third residual mixture; and separating the third precipitate from the third residual mixture.

In some aspects, the waste source comprises coal fly ash (CFA), municipal solid waste incineration ash (MSWIA), industrial solid waste incineration ash, mine tailings, or a combination thereof.

In some aspects, the plurality of target metals comprises a rare earth element (REE).

In some aspects, the plurality of target metals comprises Mg, Al, Ca, Fe, Cu, Zn, Ni, Co, Y, La, Ce, Pr, Nd, Gd, Dy, or a combination thereof.

In some aspects, a concentration factor of the plurality of target metals in the pre-concentrated feedstock is 5.0 or more (e.g., 5.5 or more, 6.0 or more, 6.5 or more, 7.0 or more, 7.5 or more, or 8.0 or more).

In some aspects, an overall recovery of the plurality of target metals is 75% or more (e.g., 80% or more, 85% or more, 90% or more, 95% or more, 97% or more, 99% or more).

In some aspects, an enrichment factor of the plurality of target metals compared to the waste source is 2.5 or more (e.g., 5 or more, 10 or more, 15 or more, 20 or more, 25 or more, 30 or more, 35 or more, or 40 or more).

In some aspects, the chelating agent comprises citric acid or a salt thereof.

In some aspects, the method also includes subjecting the third residual mixture to a post-treatment step to process undesired metal materials.

In some aspects, the post treatment process comprises hydrothermal treatment.

Also described is a system configured to perform the methods described herein.

The present disclosure further provides a system for enhancing metal recovery and/or processing from a waste source.

In some aspects, the system includes: a preprocessing unit configured to receive a waste ash source and a chelating agent to thereby form a leachate comprising one or more target metals, and wherein the preprocessing unit is configured to form a concentrated filtrate via a eutectic freeze crystallization (EFC) process; and a metal separation unit configured to receive the concentrated filtrate and a precipitation agent, wherein the metal separation unit is configured to receive a precipitation agent (e.g., one or more precipitation agents) to selectively form a solid precipitate comprising an amount of the one or more target metals.

In some aspects, the metal separation unit comprises: a first precipitation unit configured to receive the concentrated filtrate and a first precipitation agent and to selectively form a first precipitate comprising an insoluble metal-sulfide complex, and a residual mixture, and to separate the first precipitate from the residual mixture; a second precipitation unit configured to receive the residual mixture and an alkaline precipitation agent to selectively form a second precipitate comprising an insoluble metal-hydroxide, and a second residual mixture, and to separate the second precipitate from the second residual mixture; and a third precipitation unit configured to receive the second residual mixture and an oxalate precipitation agent to selectively form a third precipitate comprising an insoluble metal-oxalate complex, and a third residual mixture; and to separate the third precipitate from the third residual mixture.

In some aspects, the chelating agent comprises citric acid or a salt thereof.

In some aspects, the waste source comprises coal fly ash (CFA), municipal solid waste incineration ash (MSWIA), industrial solid waste incineration ash, mine tailings, or a combination thereof.

In some aspects, the one or more target metals comprises a rare earth element (REE).

In some aspects, the one or more target metals comprises Mg, Al, Ca, Fe, Cu, Zn, Ni, Co, Y, La, Ce, Pr, Nd, Gd, Dy, or a combination thereof.

In some aspects, a concentration factor of the plurality of target metals in the concentrated feedstock is 5.0 or more (e.g., 5.5 or more, 6.0 or more, 6.5 or more, 7.0 or more, 7.5 or more, or 8.0 or more).

In some aspects, an overall recovery of the one or more target metals is 75% or more (e.g., 80% or more, 85% or more, 90% or more, 95% or more, 97% or more, 99% or more).

In some aspects, an enrichment factor of the one or more target metals compared to the waste source is 2.5 or more (e.g., 5 or more, 10 or more, 15 or more, 20 or more, 25 or more, 30 or more, 35 or more, or 40 or more).

In further examples, disclosed herein are systems and methods that include a combined physical and chemical treatment system for maximized recovery of rare earth elements (REE) and four other critical metals (Al, Fe, Cu, and Zn) from multiple types of waste feedstocks. The example method involves the extraction of different metals using citrate from various combustion residues, such as coal fly ash (CFA) and municipal solid waste incineration ash (MSWIA). Eutectic freeze crystallization can then be used as an energy-efficient technique to preconcentrate metals in the extraction solution by crystallizing ice, which will improve the efficiency of three subsequent metal separation steps. Sulfide is first added to precipitate Cu and Zn, followed by precipitation of Al and Fe by increasing the solution pH to 9. REE are selectively precipitated using oxalate and separated from the remaining metals. This treatment system produces three major products containing valuable metals with a relatively high purity: Cu and Zn as sulfides, Al and Fe as hydroxides, and REE as oxalates, which can be further purified in downstream processes for commercialization. Overall, this system features easy operation, low energy consumption, high efficiency, and maximized recovery of valuable metals. Intensified recovery of multiple metals is a sustainable strategy with both economic and environmental benefits.

Coal fly ash (CFA) and municipal solid waste incineration ash (MSWIA) are produced in massive quantities from coal combustion and municipal solid waste incineration, respectively. A major bottleneck in metal recovery from these solid wastes is that they contain a complex composition with various metals and ligands, making it extremely challenging for target metal separation and purification.

The example implementation can be configured to selectively recover critical metals that are abundant in these solid residues, including Al, Fe, Cu, Zn, and REE. Target metal separation and purification is achieved by adding organic/inorganic ligands and adjusting pH, which are supported by thermodynamic calculations. The metals are extracted into the aqueous phase using diluted citric acid and then concentrated using the eutectic freeze crystallization (EFC) process. Subsequently, metals in the leachates are sequentially separated via three precipitation steps: (1) sulfide precipitation, (2) alkaline precipitation, and (3) oxalate precipitation. Compared to prior arts, the treatment process in this example is advantageous because of its easy operation, high efficiency, and high scalability, which could maximize the recovery of valuable metals.

An example embodiment of the present disclosure includes a method of refining minerals, including receiving a feedstock sample; performing eutectic freeze crystallization on the sample to obtain a concentrated sample; and precipitating the concentrated sample to obtain a refined product. In some embodiments, precipitating the concentrated sample includes performing a sulfide precipitation. In some embodiments, precipitating the concentrated sample includes performing an alkaline precipitation. In some embodiments, precipitating the concentrated sample includes performing an oxalate precipitation. In some embodiments, precipitating the concentrated sample includes performing more than one selective precipitation to obtain more than one type of refined product. In some embodiments, the feedstock sample includes a citrate leachate sample. In some embodiments, the feedstock sample includes a municipal solid waste incineration ash sample. In some embodiments, the feedstock sample includes a coal fly ash sample. In some embodiments, the feedstock sample includes an aqueous solution (e.g., produced water and acid mine drainage, e.g., from prior processing) or an extracted solution from a solid feedstock (e.g., mine tailings, electronic wastes, and/or scrap magnets). In some embodiments, the feedstock sample includes a leachate sample.

### BRIEF DESCRIPTION OF THE DRAWINGS

The skilled person in the art will understand that the drawings described below are for illustration purposes only.

FIG. 1A shows a schematic diagram of a system configured for intensified extraction of metals from a waste source via sequential precipitation.

FIG. 1B shows a schematic diagram of a system configured for intensified extraction of metals from a waste source via sequential precipitation. Using thermodynamic modeling based on theoretical and/or experimental measurements, recovery during sequential precipitation can be improved.

FIGS. 2A-2B each depict process flow diagrams for extracting metal products from a waste source with (FIG. 2B) and without (FIG. 2A) post-treatment processing.

FIG. 3 shows a diagram of an exemplary system utilizing eutectic freeze crystallization to extract metal from a waste source.

FIG. 4A depicts a flow diagram of a method for extracting metals from a waste source according to one example.

FIG. 4B depicts a flow diagram of a method for extracting metals from a waste source according to one example.

FIG. 4C depicts a flow diagram of a method for extracting metals from a waste source according to one example.

FIG. 5 shows an exemplary post-treatment process for converting residual material to solid zeolites.

FIG. 6 depicts an exemplary post-treatment process for CO₂ mineralization using residual material.

FIG. 7 shows a schematic overview of intensified and sequential metal recovery process in a study.

FIG. 8. The concentration factor and retained fraction of (Panel a) Ca²⁺ and (Panel b) Y³⁺ in the aqueous phase of a simulated solution during EFC (freezing temperature: −20° C.; freezing time: 540 min; initial composition of simulated solution: 10 mmol/L CaCl₂) and 10 μmol/L YCl₃. Dashed lines indicated optimal freezing time at 450 min).

FIG. 9. (Panels a-b) Thermodynamic calculations of metal speciation and (Panels c-d) experimental results of metal precipitation efficiency during sulfide precipitation in leachate (without EFC) and EFC concentrate (with EFC). Reaction conditions: sulfide dosage=15 mg; pH=4.1±0.2; reaction time=30 min.

FIG. 10. SEM images and EDX spectra of solid products from: (Panels a-b) sulfide precipitation, (Panels c-d) alkaline precipitation, and (Panels g-h) oxalate precipitation. Insets in SEM images are zoomed-in view. Black crosses denote selected points for EDX analyses. Insets in EDX spectra are pictures of solid products.

FIG. 11. (Panel a) Enrichment factors of target metals in the precipitation products compared to raw MSWIA; (Panel b) overall recovery.

FIG. 12. (Panels a-b) Thermodynamic calculations of metal speciation and (Panels c-d) experimental results of metal precipitation efficiency during alkaline precipitation in leachate (without EFC) and EFC concentrate (with EFC). Metals that were mostly removed during sulfide precipitation were not shown here. Reaction conditions: pH=9.0±0.1; reaction time=60 min.

FIG. 13. (Panels a-b) Thermodynamic calculations of metal speciation and (Panels c-d) experimental results of metal precipitation efficiency during oxalate precipitation in leachate (without EFC) and EFC concentrate (with EFC) (Metals that were mostly removed during sulfide precipitation were not shown here. Unshaded and shaded columns indicated soluble and insoluble phases, respectively; oxalate dosage=10 mg; pH=9.0±0.1; reaction time: 20 min).

FIG. 14. Major metal species in EFC concentrate during each stage as predicted by PHREEQC using log β⁰ in FIG. 28.

FIG. 15. Time profiles of (Panel a) temperature and volume of crystallized solid phase and (Panel b) solution pH during EFC process of a simulated solution (Freezing temperature: −20° C.; freezing time: 540 min; initial composition of simulated solution: 10 mmol/L CaCl₂) and 10 μmol/L YCl₃).

FIG. 16. Binary phase diagram showing the eutectic point.

FIG. 17. Decay in Cu and Zn concentrations over time during sulfide precipitation (sulfide dosage=15 mg; pH=4.0±0.2).

FIG. 18. XRD pattern of sulfide product and reference phases.

FIG. 19. SEM images of sulfide product.

FIG. 20. Decrease in Al and Fe concentrations over time during alkaline precipitation (pH=9.0±0.1).

FIG. 21. XRD pattern of alkaline product and reference patterns of major phases.

FIG. 22. SEM images of alkaline product.

FIG. 23. (Panel a) SEM image and (Panel b) EDX spectrum of a selected particle in the alkaline product that has a different morphology from the one shown in FIG. 10, panel c. Black cross denotes the selected point for EDX analysis.

FIG. 24. Decrease in total REE concentration over time during oxalate precipitation (oxalate dosage=10 mg; pH=9.0±0.1).

FIG. 25. XRD pattern of oxalate product and reference phase weddellite.

FIG. 26. Thermodynamic calculations of metal speciation in EFC concentrate during sulfide precipitation and alkaline precipitation if (Panels a-b) HCl or (Panels c-d) H₂SO₄ is used for metal leaching. Unshaded and shaded columns indicated soluble and insoluble phases, respectively. Calculation used the same solution chemistry as summarized in FIG. 27 but with HCl or H₂SO₄ as the leaching agent (instead of citrate).

FIG. 27. Input of solution chemistry for PHREEQC modeling during each precipitation process.

FIG. 28. Logarithm of stability constants (log β⁰) of metal-ligand complexes involved in a study at zero ionic strength (I=0) and 25° C. Reaction equations and corresponding values of log β⁰ were obtained from literatures and NIST Standard Reference Database (SRD) 46 (critically selected stability constants of metal complexes). Stability constants reported at I>0 were corrected to log β⁰ using the Davies Equation.

FIG. 29. Elemental compositions of raw MSWIA sample and corresponding leaching characteristics (BDL: below detection limit; N/A: not applicable. Elements of interest in this study are highlighted in bold).

FIG. 30. Concentrations of target metals in solid products of each precipitation step and corresponding product characteristics.

FIG. 31. Major metal speciation in EFC concentrate during sulfide precipitation from pH 2-8 as predicted by PHREEQC.

FIG. 32. Major metal speciation in EFC concentrate during alkaline precipitation from pH 8-11 as predicted by PHREEQC.

FIG. 33. Major metal speciation in EFC concentrate during oxalate precipitation from pH 4-10 as predicted by PHREEQC.

FIG. 34. Elemental compositions of byproducts of this treatment method (BDL: below detection limit; N/A: not applicable).

### DETAILED DESCRIPTION

To facilitate an understanding of the principles and features of various embodiments of the present invention, they are explained hereinafter with reference to their implementation in illustrative embodiments.

### Definitions

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. While implementations will be described for recovering minerals from waste materials, it will become evident to those skilled in the art that the implementations are not limited thereto, but are applicable for any other type of purification and/or recovery.

As used herein, the term “rare earth element” is intended to mean Y, Sc, and the lanthanides (La to Lu) in the Periodic Table of the Elements.

As used herein, the term coal fly ash (CFA) or fly ash means a fly ash resulting from burning coal. Reference to a specific class of CFA (e.g., Class C or Class F) is intended to refer to the chemical compositions as defined in ASTM C618-12. For example, these classes generally differ in the amount of calcium, silica, alumina, and iron content in the ash. Class F fly ash typically contains less than 20% lime (CaO), while Class C fly ash generally contains greater than 20% CaO. In one embodiment, either Class F or Class C fly ash can be used.

As used herein, the term “zeolite” refers to a family of micro-porous hydrated aluminosilicate minerals. More than 150 zeolite types have been synthesized, and 48 naturally occurring zeolites are known. Zeolites have an “open” structure that can accommodate a wide variety of cations, such as Na⁺, K⁺, Ca²⁺, Mg²⁺, and others. Some exemplary zeolites include Amicite, Analcime, Barrerite, Bellbergite, Bikitaite, Boggsite, Brewsterite, Chabazite, Clinoptilolite, Cowlesite, Dachiardite, Edingtonite, Epistilbite, Erionite, Faujasite, Ferrierite, Garronite, Gismondine, Gmelinite, Gobbinsite, Gonnardite, Goosecreekite, Harmotome, Herschelite, Heulandite, Laumontite, Levyne, Maricopaite, Mazzite, Merlinoite, Mesolite, Montesommaite, Mordenite, Natrolite, Offretite, Paranatrolite, Paulingite, Pentasil, Perlialite, Phillipsite, Pollucite, Scolecite, Sodium Dachiardite, Stellerite, Stilbite, Tetranatrolite, Thomsonite, Tschernichite, Wairakite, Wellsite, Willhendersonite, and Yugawaralite, among others.

As used herein, the term “chelating agent” refers to compounds capable of selectively removing a metal ion, such as a rare earth element, from a material. Exemplary chelating agents include oxalic acid, ethylenediaminetetraacetic acid (EDTA), diethylenetriaminepentaacetic acid (DTPA), N-(hydroxyethyl)-ethylenediaminetetraacetic acid (HEDTA), nitrilotriacetic acid (NTA), citric acid, and ascorbic acid.

As used herein, the term “precipitation agent” refers to a compound or solution of a compound that is capable of causing a solid precipitate to form as the precipitation agent contacts the leachate.

The term “extraction” refers to material removed from a substrate (e.g., a waste material) by introducing a solvent. As used herein, the term “leachate” refers to a liquid that has passed through and/or around matter, such as a waste ash source, and has extracted therefrom or otherwise contains soluble or suspended solids or any other component or aspect of the matter to which it was exposed, whether suspended or dissolved.

As used herein, the term “contacting” refers to the interaction between two or more reagents so that a physical binding reaction or a chemical reaction may take place, e.g., in a reactor and other systems described herein.

### Example Systems

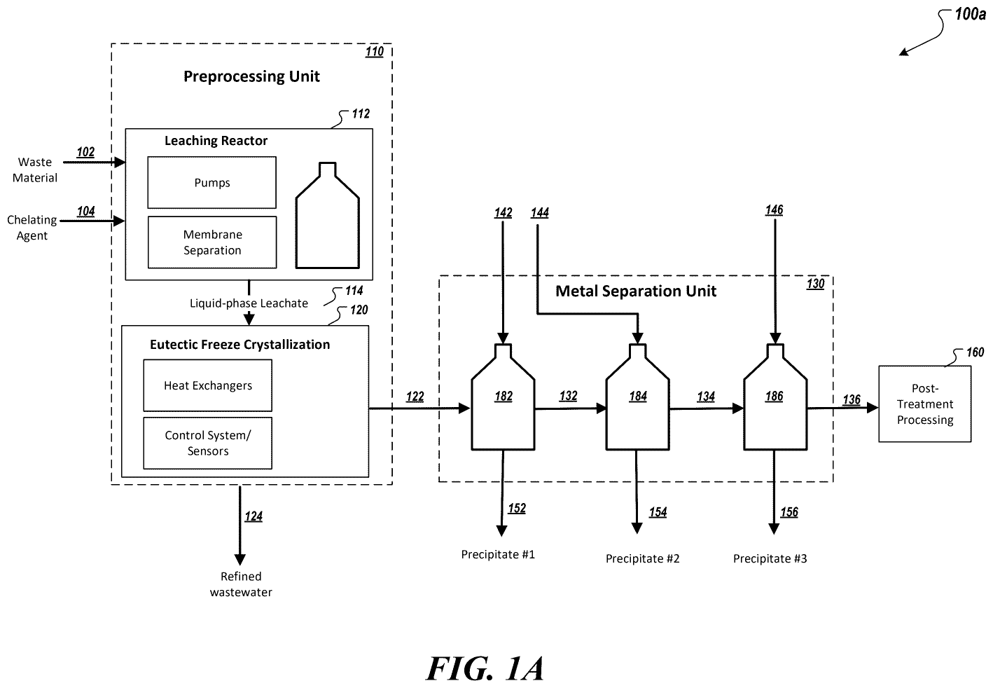

FIGS. 1A and 1B each show a schematic diagram of a system 100 (shown as 100a and 100b) for enhancing metal recovery and/or processing from a waste source.

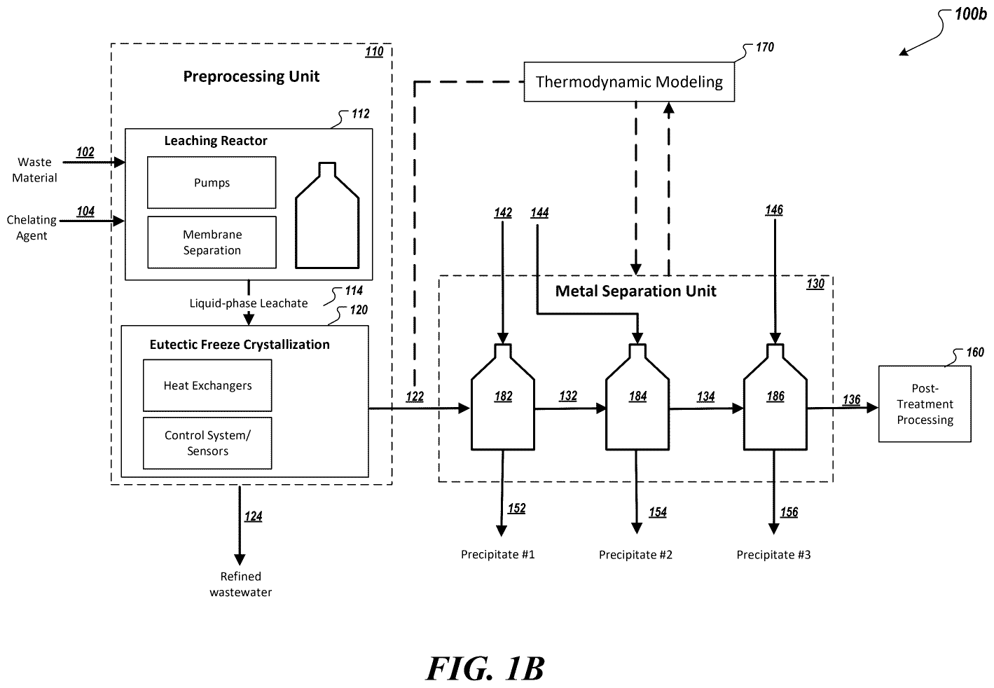

FIGS. 2A and 2B each depict flow diagrams showing a process 200 (200a, 200b) for the recovery of metal products from a waste source. The process 200 includes a waste source 202, such as a coal fly ash (CFA), municipal solid waste incineration ash (MSWIA), industrial solid waste incineration ash, or a combination thereof, mine tailings, electronic waste, or spent phosphors. The waste source is subjected to pre-processing (e.g., milling) and leaching 204 using a chelating agent before eutectic freeze crystallization 206. The solute-concentrated product from the eutectic freeze crystallization 206 then enters sequential precipitation 208 where metal products are recovered 210. Referring specifically to FIG. 2B, residual streams from the sequential precipitation 208 or other portions of the process may be subjected to post-treatment 212 for further refinement or utilization.

Referring to FIGS. 1A and 1B, the system 100a, 100b includes a preprocessing unit 110 and a metal separation unit 130. The preprocessing unit 110 includes a leaching reactor 112 that is configured to receive a waste material 102 and a chelating agent 104. The waste material 102 supplied to the leaching reactor 112 generally includes an industrial or commercial byproduct containing an amount of a target metal. The pre-processing can produce a more concentrated feed stock for rare earth separation, as well as intensify the recovery of other heavy metals with potential values, e.g., aluminum, iron, zinc, nickel, copper, among other metals and materials. In some embodiments, eutectic freeze crystallization pre-processing process is employed. The eutectic freeze crystallization is beneficial in term of energy consumption, e.g., having much lower energy consumption to traditional evaporation as well as lower setup cost. The technology is commercially adapted for several industry, e.g., food processing and food industry.

Waste material can include and not limited to coal fly ash or other solid wastes having residual target metals, such as municipal solid waste incineration ash and industrial solid waste incineration ash. Municipal solid waste incineration can include, for example, ash derived from domestic household waste, sewage sludge, medical or hospital waste, furniture, tires, textiles, plastics, rubber, cartons, and the like. Industrial solid waste incineration can include, for example, ash derived from industrial sludge, paper pulp sludge, wastepaper, waste paperboard, furniture, textiles, plastics, rubber, cartons, and tannery waste. In some aspects, the waste material can also include mine tailings. The term “mine tailings” refers to the residual material or by-products of mining operations after primary extraction. These tailings typically include various minerals and metals including, for example, gold, copper, silver, uranium, lithium, iron, aluminum, as well as other alkali metals, alkaline earth metals, transition metals, and rare earth elements. Waste materials may further include any of the above materials that have been subjected to further processing or refinement (e.g., physical/magnetic/density separation, milling, etc.) in preparation for extracting target metals.

The target metal can refer to a single metal compound intended for recovery or to a plurality of metals. In some aspects, the one or more target metals comprise a rare earth element (REE). In some aspects, the target metal includes Mg, Al, Ca, Fe, Cu, Zn, Y, La, Ce, Pr, Nd, Gd, Dy, or a combination thereof. In some aspects, the target metal includes Mg. In some aspects, the target metal includes Al. In some aspects, the target metal includes Ca. In some aspects, the target metal includes Fe. In some aspects, the target metal includes Cu. In some aspects, the target metal includes Zn. In some aspects, the target metal includes Y. In some aspects, the target metal includes La. In some aspects, the target metal includes Ce. In some aspects, the target metal includes Pr. In some aspects, the target metal includes Nd. In some aspects, the target metal includes Gd. In some aspects, the target metal includes Dy. In some aspects, the target metal includes a combination of any of the metals noted above.

The leaching reactor 112 can include various pumps, filters, valves, heat exchangers, sensors, controls, and other system components such that it is configured to receive the waste material 102 and a chelating agent 104 to thereby form a leachate 114 comprising the one or more target metals.

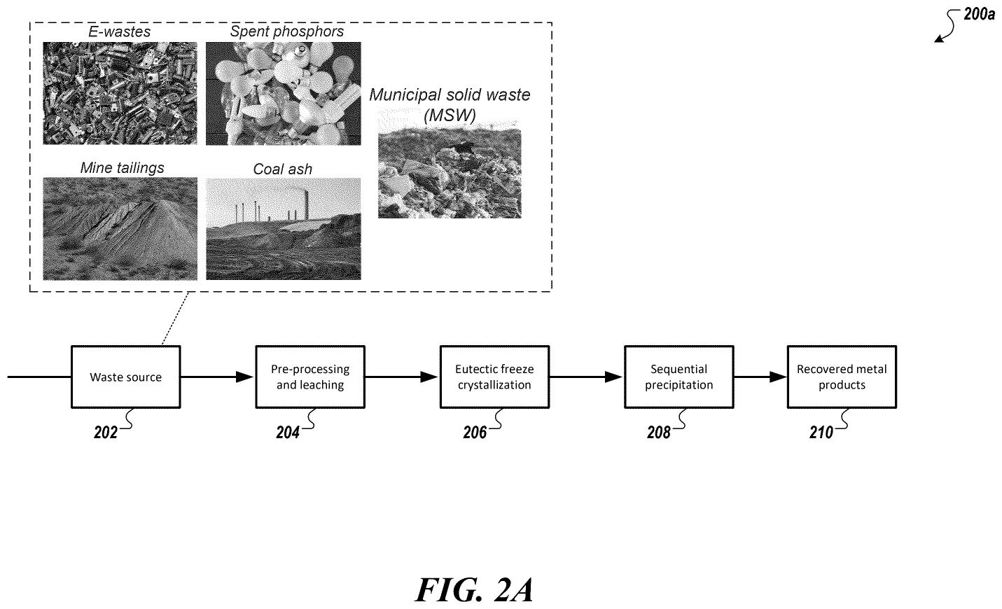

The preprocessing unit 110 is further configured to form a concentrated filtrate 122 and a refined wastewater 124 via a eutectic freeze crystallization (EFC) process 120. Briefly, EFC is a technique whereby an aqueous inorganic solution is cooled to at or near the eutectic point in order to separate/concentrate water and salts from a solution. Typically, a liquid solution is cooled such that the temperature decreases until intersecting the ice line. At the ice line, solid ice is formed which increases the concentration of the salts in the liquid phase. The system follows the ice line towards the eutectic point, which increases the amount of ice and further concentrates the liquid phase. Once at the eutectic point, the ice line intersects the solubility line of the salt and its saturation concentration is reached and further cooling will result in the simultaneous formation of ice and salt. These two solid phases may then be separated (e.g., using gravity separation) for further processing. EFC is a more energy-efficient method for water desalination and brine concentration compared to evaporative crystallization and membrane filtration. It should be noted that the EFC process 120 may occur in a separate reactor or in the leaching reactor. FIG. 3 shows a diagram of an exemplary system utilizing eutectic freeze crystallization to extract metal from a waste source. Adding the EFC pre-concentration step can significantly enhance the recovery efficiency and also the separation efficiency of the later steps described herein.

In some aspects, a concentration factor of the plurality of target metals in the pre-concentrated feedstock is 5.0 or more (e.g., 5.5 or more, 6.0 or more, 6.5 or more, 7.0 or more, 7.5 or more, or 8.0 or more). As used herein, the term, “concentration factor” refers to a ratio of the concentration of a respective metal in the concentrated filtrate over the concentration of the metal in the leachate. The concentration factor may be determined using Eq. 3. In some aspects, an overall recovery of a target metal is 75% or more (e.g., 80% or more, 85% or more, 90% or more, 95% or more, 97% or more, 99% or more). The overall recovery may be determined using Eq. 7. In some aspects, an enrichment factor of the plurality of target metals compared to the waste source is 2.5 or more (e.g., 5 or more, 10 or more, 15 or more, 20 or more, 25 or more, 30 or more, 35 or more, or 40 or more). The overall recovery may be determined using Eq. 6.

The system 100a, 100b also includes a metal separation unit 130 that is configured to receive the concentrated filtrate 122 and various precipitation agents (shown as 142, 144, 146). The metal separation unit 130 is configured such that, when contacted with the concentrated filtrate under effective conditions, the precipitation agent selectively forms a solid precipitate comprising an amount of the one or more target metals. Methods of separating solid precipitates in a liquid suspension are generally known in the art and can include, for example, centrifugation, filtration, decanting, or a combination thereof.

The metal separation unit 130 shown in FIGS. 1A-1B includes a first precipitation unit 182 configured to receive the concentrated filtrate 122 and a first precipitation agent 142 and to selectively form a first precipitate 152, and a residual mixture 132. The first precipitation unit 182 is further configured to separate the first precipitate 152 from the residual mixture 132. In some aspects, the first precipitation agent is a sulfide precipitation agent to selectively remove insoluble metal sulfides containing the target metal (e.g., Cu or Zn) from the concentrated filtrate. Non-limiting examples of sulfide precipitation agents include, for example, hydrogen sulfide, ammonium sulfide, sodium sulfide, and sodium hydrosulfide (NaSH).

The metal separation unit 130 also include a second precipitation unit 184 configured to receive the residual mixture 132 and a second precipitation agent 144 to selectively form a second precipitate 154, and a second residual mixture 134. The second precipitation unit 184 is further configured to separate the second precipitate 154 from the second residual mixture 134. In some aspects, the second precipitation agent is an alkaline precipitation agent (e.g., NaOH, KOH) to selective remove insoluble metal-hydroxides when added to the first residual mixture 132.

The metal separation unit 130 also include a third precipitation unit 186 configured to receive the second residual mixture 134 and a third precipitation agent 146 and to selectively form a third precipitate 156 and a third residual mixture 136 when the third precipitation agent 146 is added to the second residual mixture 134. The third precipitation unit 186 is further configured to separate the third precipitate 156 from the third residual mixture 136. In some aspects, the third precipitation agent is an oxalate, such that, when added to the second residual mixture, forms an insoluble metal-oxalate precipitate. Non-limiting examples of oxalates include sodium oxalate, potassium oxalate, dimethyl oxalate, and calcium oxalate.

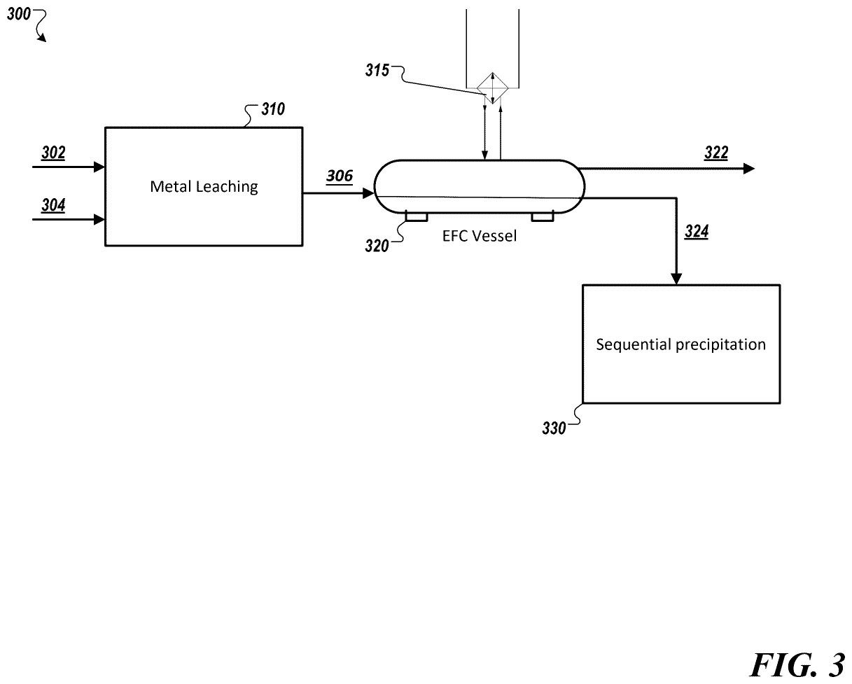

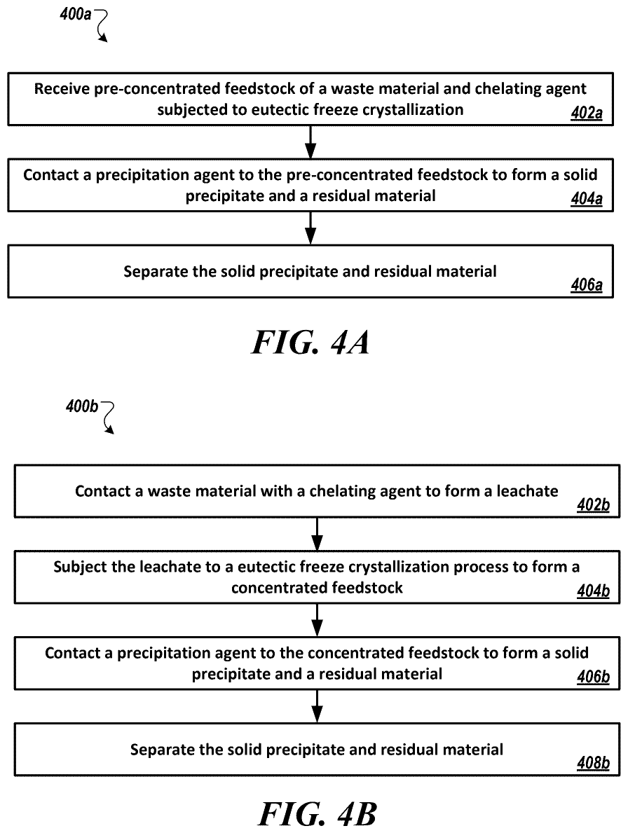

The third residual mixture 136 may further be subjected to post-treatment processing 160, such as those shown in FIGS. 5 and 6.

Although the system depicted in FIGS. 1A and 1B include three precipitation units (182, 184, 186), other systems may include fewer (e.g., 1 or 2) or more (e.g., 4, 5, 6, 7, 8, 9, 10, etc.) precipitation units depending on the particular composition of the feedstock. Moreover, the present disclosure is not limited to utilizing separate reactors for carrying out sequential precipitation stages and multiple precipitation stages may occur in a single reactor.

Referring specifically to FIG. 1B, the system 100b is further configured to receive, through sensors, information about the chemical properties of the concentrated filtrate 122 and/or any of the respective residual materials to optimize or enhance metal recovery via thermodynamic modeling 170. For example, thermodynamic modeling 170 can be used to predict the metal-ligand interactions once a precipitation agent is added, with measured solution chemistry of the concentrated filtrate as an input. The model 170 can be configured to predict interactions between the plurality of target metals, the plurality of precipitation agents, and/or the chelating agent, to determine parameters (e.g., an order) of the sequential precipitations to optimize metal recovery. Determination of these parameters can be based, at least in part, on stability constants of metal complexes for various metal-ligand pairs.

FIG. 5 depicts a system 500 is shown for post-treatment of residual feeds to form porous materials (e.g., zeolites) to minimize waste. The post-treatment system 500 includes a reactor 530 configured to receive an aluminosilicate-containing waste stream 502 and an alkaline material 504. The reactor 530 produces a processed waste material comprising zeolites 532 and a liquid waste stream 534. A portion of the liquid waste stream 534 can be collected as a recycle stream 536, where it is contacted with the aluminosilicate-containing waste stream 502 and alkaline material 504 added to the reactor 530. The system 500 shown in FIG. 5 also includes a steam turbine 520 to provide thermodynamic control of the reactor 530.

Referring now to FIG. 6, a post-treatment system 600 is shown for CO₂ mineralization 610. A residual feedstock 604 comprising a high concentration of Mg²⁺ and Ca²⁺ is contacted with a sequestered carbon dioxide feed 602 through a bubbler. Mg²⁺ and Ca²⁺ cations in the residual feedstock 604 can react with bicarbonate/carbonate formed as the CO₂ dissolves, thereby forming mineral products 620 comprising insoluble metal-bicarbonates/carbonates. The solid mineral products 620 can be separated to yield a volumetrically-reduced liquid waste 630, which can be subjected to further refinement or disposal.

### Example Eutectic Freeze Crystallization Pre-Processing System

FIG. 3 shows a diagram of an exemplary pre-processing system 300 utilizing eutectic freeze crystallization (EFC) to extract metal from a waste source 302.

In a metal leaching unit 310, a waste source and a chelating agent 304 are mixed under conditions effective to form an aqueous leachate 306 including a concentration of various metals. The aqueous leachate 306 is then distributed to an EFC vessel 320. Using a heat exchanger 315, the aqueous leachate 306 is cooled to at or near the eutectic point in order to separate/concentrate water and metal salts from the aqueous solution. The heat exchanger 315 is positioned relative to the EFC vessel 320 to cool the aqueous liquid such that the temperature of the liquid is substantially uniform throughout the vessel. The EFC vessel 320 may further include mixers, sensors, filters, and other equipment to assist with the EFC process.

The EFC vessel 320 is configured to produce a refined wastewater stream 322 and a concentrated filtrate 324. The refined wastewater stream 322 includes substantially clean water and can be discharged as wastewater, reused after simple treatments, and/or subjected to water treatment processes to further reduce remaining metal contaminates. For example, Mg²⁺ and Ca²⁺ can be removed by softening processes (e.g., ion exchange, lime-soda precipitation), whereas Al³⁺, Fe³⁺, Cu²⁺, and Zn²⁺ can be removed via coagulation and flocculation.

The concentrated filtrate 324 is then provided to a series of sequential precipitation stages 330 to selectively remove target metals. It was surprisingly shown that the utilization of a concentrated feedstock via EFC before sequential precipitation significantly increased the precipitation efficiency, product purity, and overall recovery rate of target metals.

### Example Methods

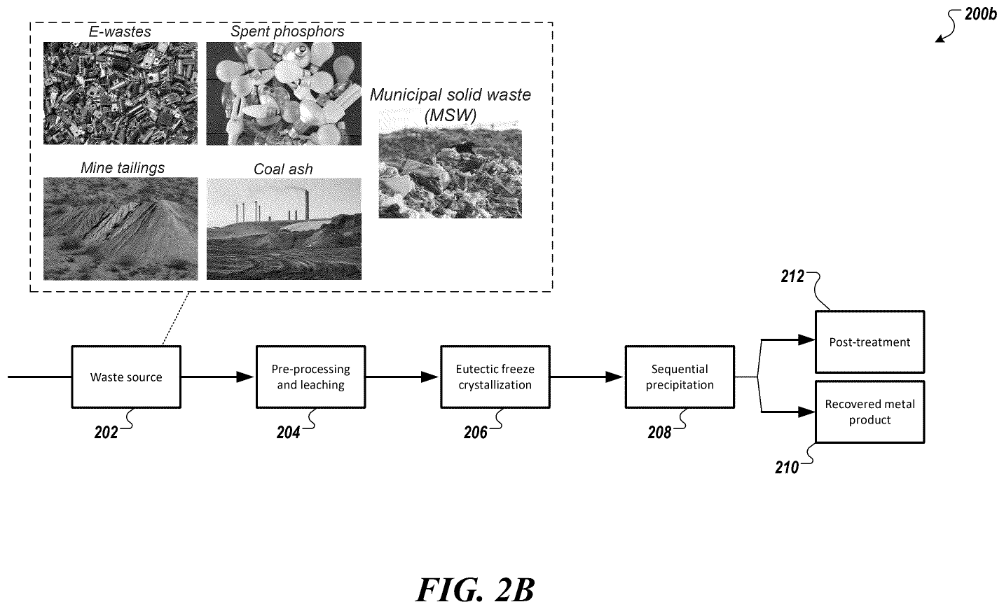

FIGS. 4A-4C each show exemplary methods (400a, 400b, 400c) used for enhancing metal recovery and/or processing from a waste source.

Referring to FIG. 4A, the method (400a) includes receiving (402a) a pre-concentrated feedstock, wherein the pre-concentrated feedstock comprises a leachate of a waste material contacted with a chelating agent (e.g., an organic ligand) that has been subjected to a eutectic freeze crystallization (EFC) process.

Method 400a further includes selectively removing one or more target metals from the pre-concentrated feedstock by contacting (404a) the pre-concentrated feedstock with a precipitation agent (e.g., one or more precipitation agents) to form a solid precipitate comprising at least one of the one or more target metal, and separating (406a) the solid precipitate from the pre-concentrated feedstock.

In some aspects, the waste source comprises coal fly ash (CFA), municipal solid waste incineration ash (MSWIA), industrial solid waste incineration ash, or a combination thereof. In some aspects, the waste source comprises mine tailings. In some aspects, the waste source comprises electronic waste.

In some aspects, selectively recovering the one or more target metals from the pre-concentrated feedstock comprises a sulfide precipitation, an alkaline precipitation, and/or an oxalate precipitation.

In some aspects, the method further includes performing sequential precipitations using a plurality of precipitation agents to selectively remove a plurality of target metals.

In some aspects, the method further includes: predicting, via thermodynamic modeling, interactions between the plurality of target metals, the plurality of precipitation agents, and/or the chelating agent, to determine parameters (e.g., an order) of the sequential precipitations to optimize metal recovery.

In some aspects, the one or more target metals comprise a rare earth element (REE). In some aspects, the target metal includes Mg, Al, Ca, Fe, Cu, Zn, Y, La, Ce, Pr, Nd, Gd, Dy, or a combination thereof. In some aspects, the target metal includes Mg. In some aspects, the target metal includes Al. In some aspects, the target metal includes Ca. In some aspects, the target metal includes Fe. In some aspects, the target metal includes Cu. In some aspects, the target metal includes Zn. In some aspects, the target metal includes Y. In some aspects, the target metal includes La. In some aspects, the target metal includes Ce. In some aspects, the target metal includes Pr. In some aspects, the target metal includes Nd. In some aspects, the target metal includes Gd. In some aspects, the target metal includes Dy. In some aspects, the target metal includes a combination of any of the metals noted above.

In some aspects, a concentration factor of the one or more target metals in the pre-concentrated feedstock is 5.0 or more (e.g., 5.5 or more, 6.0 or more, 6.5 or more, 7.0 or more, 7.5 or more, or 8.0 or more).

In some aspects, an overall recovery of the one or more target metals is 75% or more (e.g., 80% or more, 85% or more, 90% or more, 95% or more, 97% or more, 99% or more).

In some aspects, an enrichment factor of the one or more target metals compared to the waste material is 2.5 or more (e.g., 5 or more, 10 or more, 15 or more, 20 or more, 25 or more, 30 or more, 35 or more, or 40 or more).

In some aspects, the chelating agent comprises citric acid or a salt thereof. In some aspects, the method also includes substantially separating a purified metal product from the solid precipitate.

In some aspects, the method includes subjecting a residual stream of the pre-concentrated feedstock following removal of the one or more target metals to a post-treatment step to process undesired metal materials. In some aspects, the post treatment step comprises a hydrothermal treatment process to form zeolites. In some aspects, the post treatment step comprises a CO₂ mineralization process.

Referring now to FIG. 4B, shown is a method 400b for enhancing metal recovery and/or processing from a waste source. Method (400b) includes contacting (402b) a waste source containing one or more target metals (e.g., a waste ash) with a chelating agent (e.g., an organic ligand) to form a leachate. Method (400b) further includes subjecting (404b) the leachate to a eutectic freeze crystallization (EFC) process to concentrate the one or more target metals in a concentrated feedstock. The concentrated feedstock is subsequently contacted (406b) with a precipitation agent (e.g., one or more precipitation agents) to selectively remove the one or more target metals from the concentrated feedstock and form a solid precipitate comprising at least one of the one or more target metal. Method (400b) also includes separating (408b) the solid precipitate and the residual material.

In some aspects, the waste source comprises coal fly ash (CFA), municipal solid waste incineration ash (MSWIA), industrial solid waste incineration ash, or a combination thereof. In some aspects, the waste source comprises mine tailings. In some aspects, the waste source comprises electronic waste.

In some aspects, selectively recovering the one or more target metals from the concentrated feedstock comprises a sulfide precipitation, an alkaline precipitation, and/or an oxalate precipitation.

In some aspects, the method also includes performing sequential precipitations using a plurality of precipitation agents to selectively remove a plurality of target metals.

In some aspects, the one or more target metals comprise a rare earth element (REE). In some aspects, the target metal includes Mg, Al, Ca, Fe, Cu, Zn, Y, La, Ce, Pr, Nd, Gd, Dy, or a combination thereof. In some aspects, the target metal includes Mg. In some aspects, the target metal includes Al. In some aspects, the target metal includes Ca. In some aspects, the target metal includes Fe. In some aspects, the target metal includes Cu. In some aspects, the target metal includes Zn. In some aspects, the target metal includes Y. In some aspects, the target metal includes La. In some aspects, the target metal includes Ce. In some aspects, the target metal includes Pr. In some aspects, the target metal includes Nd. In some aspects, the target metal includes Gd. In some aspects, the target metal includes Dy. In some aspects, the target metal includes a combination of any of the metals noted above.

In some aspects, a concentration factor of the one or more target metals in the concentrated feedstock is 5.0 or more (e.g., 5.5 or more, 6.0 or more, 6.5 or more, 7.0 or more, 7.5 or more, or 8.0 or more).

In some aspects, an overall recovery of the one or more target metals is 75% or more (e.g., 80% or more, 85% or more, 90% or more, 95% or more, 97% or more, 99% or more).

In some aspects, an enrichment factor of the one or more target metals compared to the waste source is 2.5 or more (e.g., 5 or more, 10 or more, 15 or more, 20 or more, 25 or more, 30 or more, 35 or more, or 40 or more).

In some aspects, the chelating agent comprises citric acid or a salt thereof.

FIG. 4C shows a method (400c) for enhancing metal recovery and/or processing from a waste source. The method (400c) includes: contacting (402c) a waste source (e.g., a waste ash) containing a plurality of target metals with a chelating agent (e.g., an organic ligand) to form a leachate. Method (400c) also includes subjecting (404c) the leachate to a eutectic freeze crystallization (EFC) process to concentrate the plurality of target metals in a concentrated feedstock. Method (400c) further includes contacting (406c) the concentrated feedstock with a sulfide precipitation agent to selectively form a first precipitate comprising an insoluble metal-sulfide complex, and a residual mixture. The first precipitate is then separated (408c) from the residual mixture before contacting (410c) the residual mixture with an alkaline precipitation agent to selectively form a second precipitate comprising an insoluble metal-hydroxide, and a second residual mixture. Following this, method (400c) includes separating (412c) the second precipitate from the second residual mixture. The second residual mixture is then contacted (414c) with an oxalate precipitation agent to selectively form a third precipitate comprising an insoluble metal-oxalate complex, and a third residual mixture. Method (400c) further includes separating (416c) the third precipitate from the third residual mixture.

In some aspects, the waste source comprises coal fly ash (CFA), municipal solid waste incineration ash (MSWIA), industrial solid waste incineration ash, or a combination thereof. In some aspects, the waste source comprises mine tailings. In some aspects, the waste source comprises electronic waste.

In some aspects, the one or more target metals comprise a rare earth element (REE). In some aspects, the target metal includes Mg, Al, Ca, Fe, Cu, Zn, Y, La, Ce, Pr, Nd, Gd, Dy, or a combination thereof. In some aspects, the target metal includes Mg. In some aspects, the target metal includes Al. In some aspects, the target metal includes Ca. In some aspects, the target metal includes Fe. In some aspects, the target metal includes Cu. In some aspects, the target metal includes Zn. In some aspects, the target metal includes Y. In some aspects, the target metal includes La. In some aspects, the target metal includes Ce. In some aspects, the target metal includes Pr. In some aspects, the target metal includes Nd. In some aspects, the target metal includes Gd. In some aspects, the target metal includes Dy. In some aspects, the target metal includes a combination of any of the metals noted above.

In some aspects, a concentration factor of the plurality of target metals in the pre-concentrated feedstock is 5.0 or more (e.g., 5.5 or more, 6.0 or more, 6.5 or more, 7.0 or more, 7.5 or more, or 8.0 or more).

In some aspects, an overall recovery of the plurality of target metals is 75% or more (e.g., 80% or more, 85% or more, 90% or more, 95% or more, 97% or more, 99% or more).

In some aspects, an enrichment factor of the plurality of target metals compared to the waste source is 2.5 or more (e.g., 5 or more, 10 or more, 15 or more, 20 or more, 25 or more, 30 or more, 35 or more, or 40 or more).

In some aspects, the chelating agent comprises citric acid or a salt thereof.

In some aspects, the method also includes subjecting the third residual mixture to a post-treatment step to process undesired metal materials.

In some aspects, the post treatment process comprises hydrothermal treatment.

It should be understood that the leachate can optionally be any type of feedstock. For example, the feedstock can be a ligand-assisted extraction solution prepared from coal fly ash, municipal solid waste incineration, a direct aqueous solution (e.g., produced water and acid mine drainage), a solution extracted from other solid feedstocks (e.g., mine tailings, electronic wastes, and/or scrap magnets), and/or any other feedstock. In some aspects, precipitating the concentrated sample includes performing more than one selective precipitation to obtain more than one type of refined product.

### EXPERIMENTAL RESULTS AND ADDITIONAL EXAMPLES

### Example #1

The treatment system in the example embodiment was designed to recover purified REE and four other critical metals (Al, Fe, Cu, Zn) from emerging combustion residue, including CFA and MSWIA. This system enables selective and efficient separation of multiple valuable metals from leachates by varying solution chemistry (e.g., adding organic/inorganic ligands, adjusting pH) and produces three purified solid products: Cu and Zn as sulfides, Al and Fe as hydroxides, and REE as oxalates. EFC, as a pre-concentration step, enhances the metal separation efficiency and results in a higher product purity.

The feedstocks are first mixed with sodium citrate under continuous stirring at room temperature. The reaction conditions used follow those shown to have the highest recovery for the particular waste source: 4 hours of reaction time, 50 mM citrate, pH 4, 200 mL/g of liquid-to-solid ratio. The mixture is then filtered using vacuum filtration to collect the leachate. During EFC, the leachate is placed in a fridge at −20° C. for 450 min to slowly crystallize ice. The liquid residue containing concentrated metals is collected via filtration and used for subsequent precipitation processes.

During sulfide precipitation, an optimal concentration of sodium sulfide is added to the leachate to precipitate Cu and Zn as sulfides, and the mixture is reacted for 30 min under stirring. The solid product is collected via vacuum filtration and dried in the oven at 60° C. overnight.

During alkaline precipitation, 5.0 M NaOH solution is slowly added to the liquid residue from the previous step to adjust the solution pH to 9.0, and the mixture is reacted for 60 min under stirring. The solid product containing Al and Fe hydroxides is collected via vacuum filtration and dried in an oven at 60° C. overnight. During oxalate precipitation, an optimal concentration of sodium oxalate is added to the liquid residue to precipitate REE with calcium oxalate, and the mixture is reacted for 20 min under stirring. The solid product is collected via vacuum filtration and dried in an oven at 60° C. overnight.

### Example #2

Rare earth elements (REE) are the “essential vitamins” that fuel our transition from fossil-based energy to a clean energy infrastructure powered by electricity, wind, and solar energy [1, 2]. While global energy transition is driving the surging demand for REE, there is a strong consensus that supply chain will soon become the major bottleneck, posing unprecedented pressures to resource exploration, extraction, and manufacturing [2, 3]. Because of this, REE have been labeled by the U.S. and European Union as “critical minerals” with high and imminent risk of supply disruption [4]. For decades, REE production predominantly relies on conventional mining of natural deposits, which typically involves energy- and pollution-intensive metallurgical techniques [1, 2, 5]. Following extraction, hundreds of steps of liquid-liquid extraction using hazardous organic solvents (e.g., kerosene) are repeated to produce purified REE products [6, 7]. The estimated cradle-to-gate life cycle impacts of producing 1 kg of REE oxide include: carbon footprint of 105-236 kg CO₂ eq., acidification of 1.14-1.64 moles H⁺ eq., ecotoxicity of 525-2020 kg 2,4-D eq., and smog of 14.8-18.9 kg NOx eq [8]. The heavy pollution and high remediation costs associated with traditional mining warrant the search for more sustainable alternative resources and technologies for REE production [9].

Recycling and recovery of REE from secondary or waste feedstocks have great potential to strengthen the REE supply chain, close the material flow loop, reduce environmental pollution, and valorizes wastes [10-13]. REE recovery from different waste feedstocks, including electronic wastes, phosphors, mine tailings, and incineration byproducts, has been under the spotlight of recent research [12, 14-23]. However, low REE concentration (total REE of <500 mg/kg) and the co-presence of many interfering metals (e.g., Mg, Al, Ca, Fe) in these wastes raise technical and economic challenges for REE recycling in real applications [13, 14, 24-27]. In practice, less than 1% of used REE in the U.S. is recycled, most of which come from spent magnets in wind turbines with a relatively high REE content and purity [24]. The recovered REE products in most previous studies typically have low REE and/or high impurity contents, and the other co-extracted metals are not recovered. In order to maximize the overall economic benefits, technology development for enhanced recovery of REE and other valuable metals is highly desired. After metal extraction, pre-concentration and volume reduction of leachate are also necessary for downstream processing [24]. Eutectic freeze crystallization (EFC) is a novel technique that separates aqueous solutions into pure ice and crystallized solutes by freezing at the eutectic point [28]. It is a more energy-efficient method for water desalination and brine concentration compared to evaporative crystallization and membrane filtration (e.g., enthalpy of fusion for water is only 1/7 of its enthalpy of vaporization) [29].

Strong mineral acids (e.g., HCl and H₂SO₄) have been widely used for REE extraction, which unfortunately comes with heavy chemical input and adverse environmental impacts [30-32]. To overcome these limitations, organic ligands with strong metal complexing ability have been considered as greener alternatives, which can facilitate metal extraction through forming soluble metal-ligand complexes [33-35]. For example, citrate is a biodegradable organic ligand that can effectively extract REE from various feedstocks [36, 37]. However, the impacts of leaching ligands on downstream processing and overall metal recovery have been largely overlooked because the ligands of traditionally used mineral acids (e.g., Cl⁻) typically have weak complexing ability for metals [34]. For metal recovery processes that involve organic acids, this is especially important because the efficiency and selectivity of post-leaching separation and precipitation processes are largely governed by competitive metal-ligand interactions [38]. Ideally, the selected organic ligand should promote metal leaching from feedstocks by forming soluble metal-ligand complexes. During precipitation, precipitating ligands are added to outcompete the leaching ligand and form insoluble complexes with target metals. Therefore, we aimed to identify a suitable set of leaching/precipitating ligands can protect target metals from precipitating in premature steps and allow rapid precipitation at the designated step, making sequential and selective metal recovery possible. Developing such a method requires a comprehensive understanding of competitive metal-ligand complexation, and a systematic study in this direction supported by thermodynamic calculation is still missing.

To address these challenges, this study aimed to (1) employ EFC as an energy-efficient physical freezing technique to pre-concentrate metals in the leachate and reduce the leachate volume, (2) develop an effective treatment method for sequential recovery of REE and other valuable metals via three chemical precipitation processes, and (3) elucidate the underlying metal-ligand interactions and impact of citrate on these precipitation processes using thermodynamic modeling. Building upon the characterization of REE and other metal speciation in waste feedstocks such as coal fly ash [25, 39-42] and municipal solid waste incineration ash (MSWIA) [43], our recent work demonstrated the high efficiency of citrate-assisted extraction of REE and other metals from MSWIA [12], coal fly ash [14], and REE-bearing carbonate/phosphate minerals [44]. This study uses the citrate leachate from MSWIA as a representative feedstock, and we aimed to maximize the recovery of REE and four other abundant valuable metals (Al, Fe, Cu, Zn). Achieving these objectives will allow us to demonstrate a feasible REE recovery method that integrates physical concentration and chemical precipitation. This intensified recovery method features the selective recovery of REE and multiple valuable metals, which can potentially address the major limitation of existing REE recovery techniques. In addition, elucidating the metal-ligand complexation and dominant metal species involved in each process can provide mechanistic insights for the advantages of using organic ligands compared to mineral acids in metal recovery.

### Materials and Methods

All chemicals used in this study are ACS grade or higher without further purification. MSWIA sample was obtained from a Waste-to-Energy facility located in Northwest USA. Details on the chemicals, MSWIA sample processing, characterization techniques, and analytical methods are discussed below.

Chemicals and reagents. Sodium dihydrogen citrate (>99.0%) was purchased from Alfa Aesar (Haverhill, USA). Sodium sulfide nonahydrate (>98.0%) was purchased from MP Biomedicals (Santa Ana, USA). Calcium chloride dihydrate (>99.0%), yttrium chloride anhydrous (99.9%), sodium oxalate (>99.0%), hydrochloric acid (ACS grade, 36.5-38%), and sodium hydroxide pellets (>97.0%) were purchased from VWR (Radnor, USA). Indium internal standard (TraceCERT) and REE mix standard (TraceCERT) were purchased from Sigma-Aldrich (St. Louis, USA). Multi-element standard (Solution 2A) was purchased from SPEX CertiPrep (Metuchen, USA). Ultrapure deionized water (18.2 MΩ·cm) produced by a Barnstead Nanopure system (Thermo Fisher Scientific, Waltham, USA) was used in all solutions.

Municipal solid waste incineration ash (MSWIA) sample. The as-received MSWIA sample was grinded to fine powders using a pestle and mortar and then size fractionated using a mesh 140 standard testing sieve (pore size 106 μm). The morphology, mineralogy, and elemental composition of raw MSWIA sample were determined using scanning electron microscopy (SEM), X-ray diffraction (XRD), X-ray fluorescence (XRF), microwave digestion followed by inductively coupled plasma mass spectrometry (ICP-MS). Microwave digestion was performed in an Anton Paar Multiwave 5000 microwave reaction system (Anton Paar, Graz, Austria) using 3:1 concentrated HCl:HNO₃ as the digestion reagent (200° C., 2 hrs). The digestate was diluted and analyzed for REE concentration using ICP-MS. Details about XRF analysis can be found in a previous study [12].

Scanning electron microscopy coupled with energy dispersive X-ray spectroscopy (SEM-EDX). The morphology of raw MSWIA sample and precipitation products from each step was examined using a Hitachi SU8320 SEM (Hitachi, Tokyo, Japan) coupled with Oxford X-Max^{N} EDX (Oxford Instruments, Abingdon, U.K.). Samples were dusted onto a carbon tape. One layer of carbon coating (˜15-20 nm thickness) was applied to all samples using a Quorum Q150V Plus coater (Quorum Technologies, Lewes, U.K.). SEM images were taken at 10 kV, 10 mA, and a working distance of 4.0 mm. Point spectra of target elements were taken at 20 kV, 30 mA, and a working distance of 15.0 mm.

X-ray diffraction (XRD). The mineralogy and phase identification of the raw MSWIA sample and precipitation products from each step were analyzed using a Rigaku MiniFlex X-ray diffractometer (Rigaku, Tokyo, Japan). Data were collected from 10 to 80°2θ with a step size of 0.01° and scan speed of 10°/min. Cu Kα (1.5406 Å) was used as the radiation source. The operation voltage and current were 40 kV and 15 mA, respectively. The collected XRD patterns were processed using HighScore and refined using the Rietveld method with phase ID reference patterns sourced from the International Centre for Diffraction Data (ICDD) database.

Inductively coupled plasma mass spectrometry (ICP-MS). The elemental concentrations in all aqueous samples were measured using an Agilent 7900 ICP-MS (Santa Clara, USA). Argon was used as the ionizing gas, and data was measured in a helium acquisition mode to minimize isobaric interference. The instrument was auto-tuned for high sensitivity, low isobaric interference (MO⁺/M⁺<1%), and low doubly charged ions (M⁺⁺<2%). All calibration standards (0-400 μg/L) and samples were prepared in 2% HNO₃ and spiked with 20 ppb of indium (In) as the internal standard. The elemental isotopes that were measured include: ²³Na, ²⁴Mg, ²⁷Al, ³⁹K, ⁴⁰Ca, ⁴⁵Sc, ⁴⁸Ti, ⁵³Cr, ⁵⁵Mn, ⁵⁶Fe, ⁵⁹Co, ⁶⁰Ni, ⁶³Cu, ⁶⁶Zn, ⁷⁵As, ⁸⁸Sr, ⁸⁹Y, ¹¹¹Cd, ¹¹⁵In, ¹³⁷Ba, ¹³⁹La, ¹⁴⁰Ce, ¹⁴¹Pr, ¹⁴⁶Nd, ¹⁴⁷Sm, ¹⁵³Eu, ¹⁵⁷Gd, ¹⁵⁹Tb, ¹⁶³Dy, ¹⁶⁵Ho, ¹⁶⁶Er, ¹⁶⁹Tm, ¹⁷²Yb, and ¹⁷⁵Lu. The linear regression equation of the standard calibration curve was determined to calculate metal concentrations in all samples.

Metal extraction from raw MSWIA sample via citrate leaching. Metals were leached from raw MSWIA using citrate following the same procedures described in [12]. The metal leaching efficiency was calculated using Eq. 1:

$$Leaching efficiency ( \% ) = \frac{{C}_{L e a c h a t e} \cdot {V}_{L e a c h a t e}}{{C}_{A s h} \cdot {m}_{A s h}} \times 100 \% \qquad ( 1 )$$

where C_{Ash} and C_{Leachate} (mg/kg) are the metal concentrations in raw MSWIA sample and citrate leachate, respectively; V_{Leachate} (mL) is the leachate volume; m_{Ash} (g) is the mass of MSWIA.

Pre-concentration via eutectic freeze crystallization (EFC). EFC was first performed on a simulated solution containing 10 mmol/L CaCl₂ and 10 μmol/L YCl₃ in a fridge (freezing temperature: −20° C.). Every 30 min, samples were collected to measure metal concentrations, and the solution pH, temperature, and volume of solid phase were determined. Based on preliminary results, EFC was then performed on the leachate at a freezing temperature of −20° C. and an optimal reaction time of 450 min. The filtrate (noted as EFC concentrate) was collected via vacuum filtration, and metal concentrations were determined using ICP-MS. The fraction of metals retained in the aqueous phase after EFC is calculated via Eq. 2, and the concentration factor is calculated via Eq. 3:

$$Fraction retained ( \% ) = \frac{{C}_{E F C} \cdot {V}_{E F C}}{{C}_{L e a c h a t e} \cdot {V}_{L e a c h a t e}} \times 100 \% \qquad ( 2 )$$

$$Concentration factor = \frac{{C}_{E F C}}{{C}_{L e a c h a t e}} \qquad ( 3 )$$

where C_{EFC} (mg/kg) is the metal concentrations in EFC concentrate; V_{EFC} (L) is the volume of EFC concentrate.

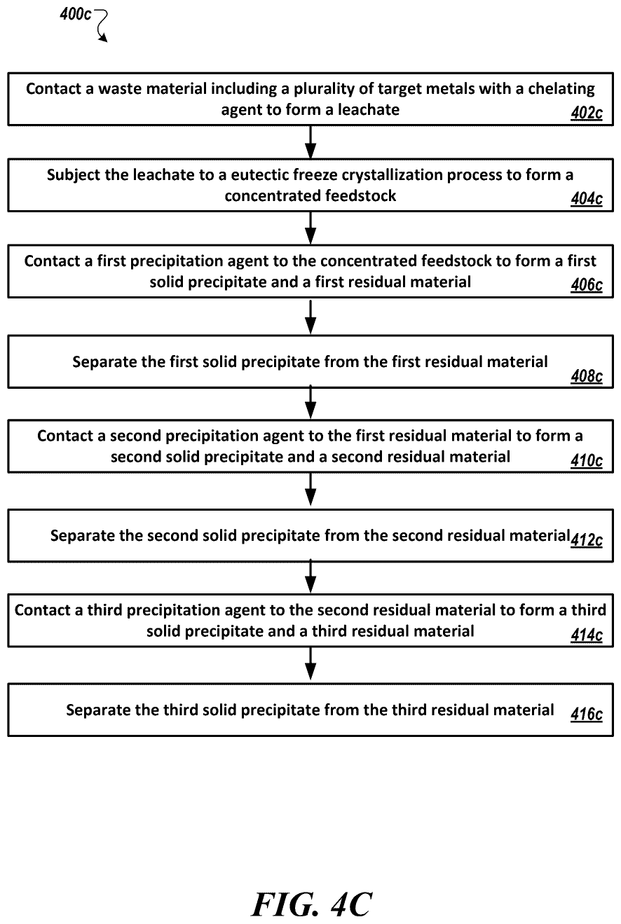

Sequential metal separation via chemical precipitation. In order to selectively precipitate target metals, three chemical precipitation processes were sequentially performed as described below: Cu and Zn via sulfide precipitation, Al and Fe via alkaline precipitation, and REE via oxalate precipitation. A schematic overview of the overall system is presented in FIG. 7. Dosages of sulfide and oxalate were pre-determined based on the total amount of target metals in feedstocks and reaction stoichiometry. To examine the effect of EFC pre-concentration, the same mass of sulfide and oxalate was added to the EFC concentrate and original leachate without EFC.

Sulfide precipitation for Cu and Zn recovery. 15 mg of sodium sulfide was added to the solutions under stirring and reacted for 30 min. The mixture was filtered via vacuum filtration (pore size 0.2 μm), and the filtrate was collected (noted as sulfide filtrate). The solid product (noted as sulfide product) was dried in an oven at 60° C. overnight and then characterized using X-ray diffraction (XRD) and scanning electron microscopy energy dispersive spectroscopy (SEM-EDX).

Alkaline precipitation for Al and Fe recovery. The solution pH of sulfide filtrate was titrated to 9.0±0.1 using 5.0 mol/L NaOH solution, and the mixture was stirred for 60 min. The increase in solution volume (<1%) was considered when calculating metal concentrations. The solid product (noted as alkaline product) and filtrate (noted as alkaline filtrate) were collected and characterized following the same procedures.

Oxalate precipitation for REE recovery. 10 mg of sodium oxalate was added to the alkaline filtrate under stirring and reacted for 20 min. The solid product (noted as oxalate product) and filtrate (noted as oxalate filtrate) were collected and characterized following the same procedures.

The precipitation efficiency of target metals during each step, their concentrations (mg/kg) in the solid products, enrichment factors compared to raw MSWIA, and overall recovery rate were calculated using Eqs. 4-7:

$$Precipitation efficiency ( \% ) = \frac{{C}_{P r e - reaction} - {C}_{Filtrate}}{{C}_{P r e - reaction}} \times 100 \% \qquad ( 4 )$$

$$Metal concentration in solid product = \frac{( {C}_{P r e - reaction} - {C}_{Filtrate} ) \cdot {V}_{Filtrate}}{{m}_{P roduct}} \qquad ( 5 )$$

$$Enrichment factor = \frac{{C}_{p roduct}}{{C}_{A s h}} \qquad ( 6 )$$

$$Overall recovery ( \% ) = \frac{{C}_{p roduct} \cdot {m}_{p roduct}}{{C}_{A s h} \cdot {m}_{A s h}} \times 100 \% \qquad ( 7 )$$

where C_{Pre-reaction} and C_{Filtrate} (mg/kg) are the metal concentrations in the solution before and after precipitation, respectively; V_{Filtate} (L) is the volume of filtrate; m_{Product} (mg) is the dry mass of solid product; C_{product} (mg/kg) is the metal concentration in solid product calculated by Eq. 5.

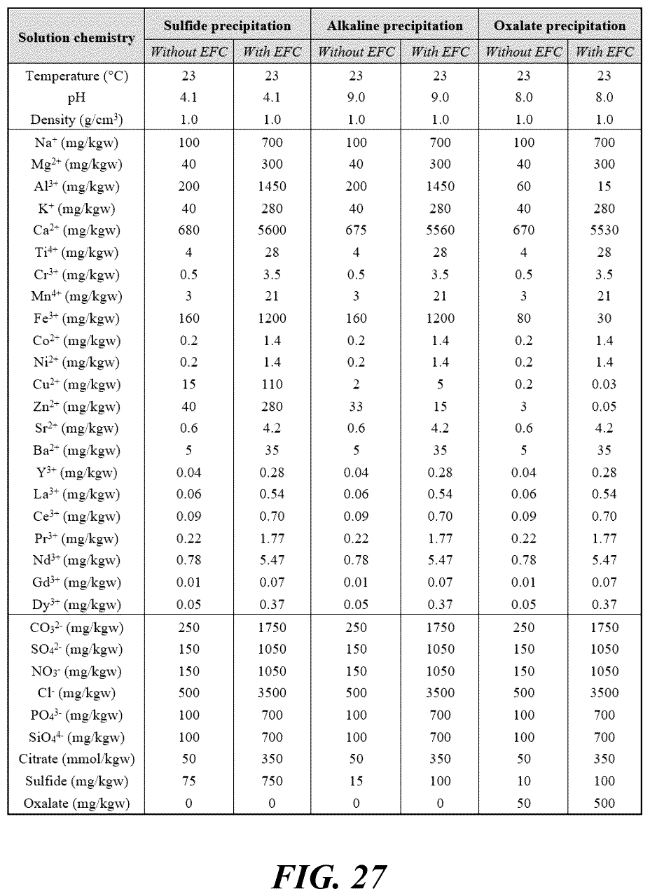

Thermodynamic modeling. The thermodynamics of interactions between target metals and different ligands, including major species of metal-ligand complexations and relevant saturation index (SI) in each precipitation process were calculated using the software PHREEQC version 3. Input of solution chemistry was based on experimental measurements and was summarized in FIG. 27. The minteq.v4.dat database with additional stability constants (log β) of metal-ligand complexes introduced from the NIST Standard Reference Database (SRD) 46 (critically selected stability constants of metal complexes) and literatures was used for modeling [34, 45-60]. Values of log β reported at ionic strength (I) >0 were corrected to log β⁰ (at I=0) as described below.

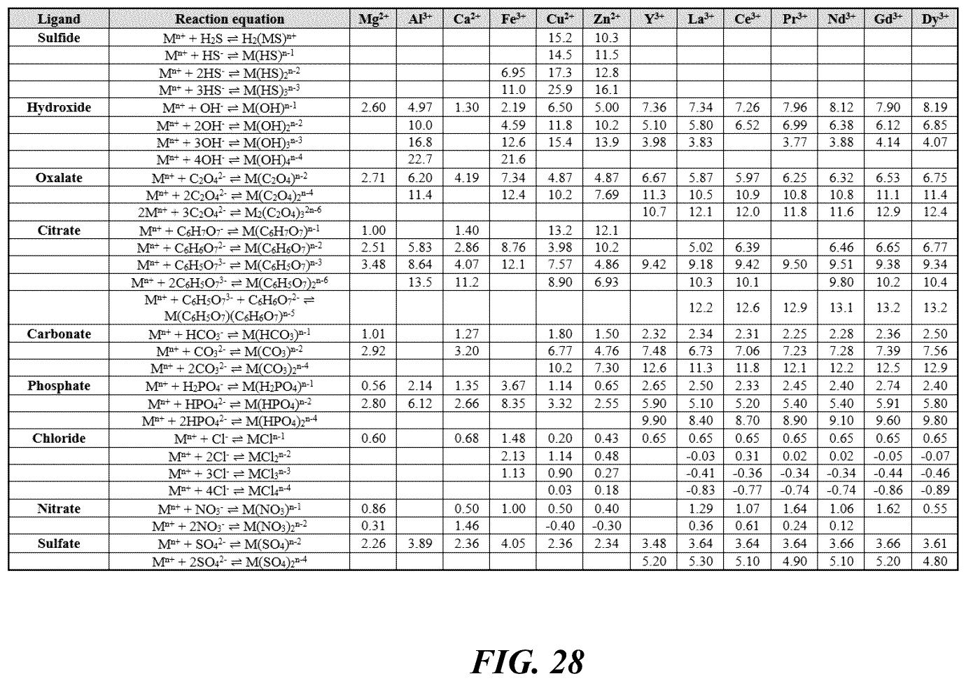

Briefly, the calculated and other relevant log β⁰ obtained from literatures were summarized in FIG. 28. For a general complexation reaction between a metal and a ligand (Eq. 8):

$${M}^{m +} + x {L}^{n -} ↔ M {L}_{x}^{m - n x} \qquad ( 8 )$$

where

$${M}^{m +} , {L}^{n -} , {ML}_{x}^{m - nx}$$

represents metal cation, ligand anion, and metal-ligand complex, respectively. The stability constants β⁰ can be written as Eq. 9:

$${β}^{0} = \frac{[ M {L}_{x}^{m - n x} ]}{{[ {L}^{n -} ]}^{x} \cdot [ {M}^{m +} ]} \cdot \frac{{γ}_{M {L}_{n}^{m - n x}}}{{( {γ}_{{L}^{n -}} )}^{x} \cdot {γ}_{{M}^{m +}}} = β \cdot \frac{{γ}_{M {L}_{n}^{m - n x}}}{{( {γ}_{{L}^{n -}} )}^{x} \cdot {γ}_{{M}^{m +}}} \qquad ( 9 )$$

where values in brackets represent species concentrations; γ is the activity coefficient, and β is the measured stability constant at I. Eq. 10 can be written as follows by taking logarithm of Eq. 9. γ can be estimated using the Davies Equation (Eq. 11), where zᵢ is the charge of species.

$$log ( {β}^{0} ) = log ( β ) + [ log ( {γ}_{M {L}_{n}^{m - nx}} ) - x log ( {γ}_{{L}^{n -}} ) - log ( {γ}_{{M}^{m +}} ) ] \qquad ( 10 )$$

$$log ( {γ}_{i} ) = - 0.51 {z}_{i}^{2} [ \frac{\sqrt{I}}{1 + \sqrt{I}} - 0.3 I ] \qquad ( 11 )$$

### Results and Discussion

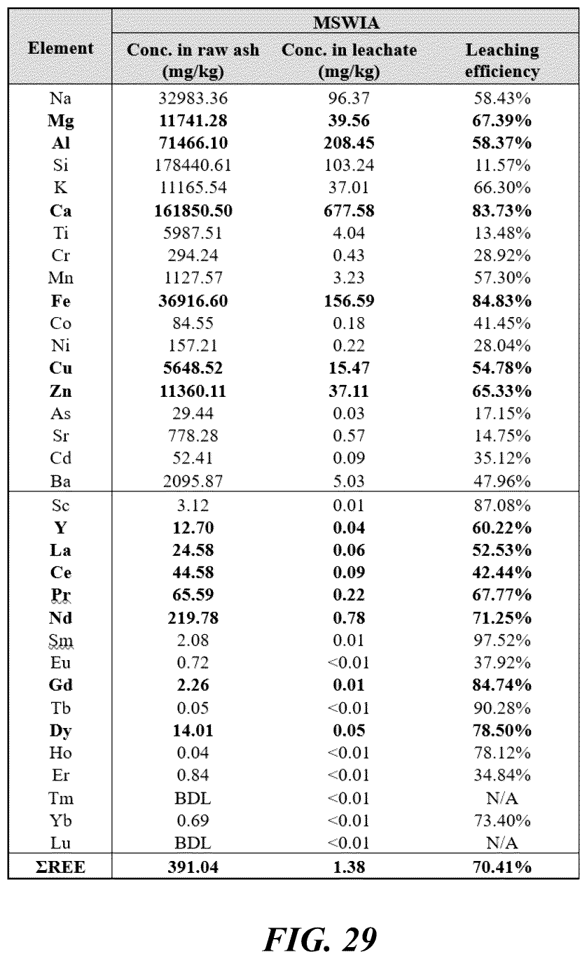

Metal extraction from MSWIA via citrate leaching. Details on the reaction procedure, characterization, and citrate leaching of MSWIA can be found in [12]. Major crystalline phases in MSWIA included calcium-, aluminum-, and magnesium-bearing carbonates and silicates. Microwave digestion of the MSWIA sample using aqua regia led to a quasi-complete matrix decomposition, with the only solid residue being a trace amount of transparent silicates. Using synchrotron X-ray absorption spectroscopy (XAS) and microscopy elucidated that REE in MSWIA were primarily associated with phosphate minerals (e.g., xenotime) and iron oxides (e.g., hematite) [43], complete REE extraction from microwave digestion was assumed. The MSWIA sample contained 391 mg/kg of total REE, with particularly high Pr and Nd concentrations that was likely originated from electronic wastes. It also contained abundant non-REE, especially Mg, Al, Si, Ca, Fe, Cu, and Zn (FIG. 29). The metal leaching efficiency from MSWIA by citrate widely ranged from 20 to 98% (Eq. 1), which, without wishing to be bound by theory, depends on the physical distribution and chemical speciation of these metals. Based on the metal concentrations in leachate (FIG. 29), the present study selected Al, Fe, Cu, Zn, and seven REE (Y, La, Ce, Pr, Nd, Gd, Dy) as the target metals for sequential recovery.

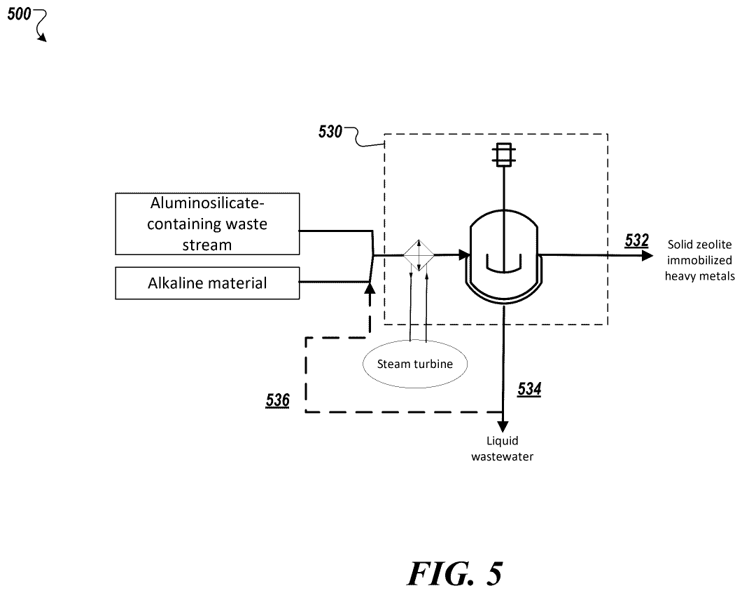

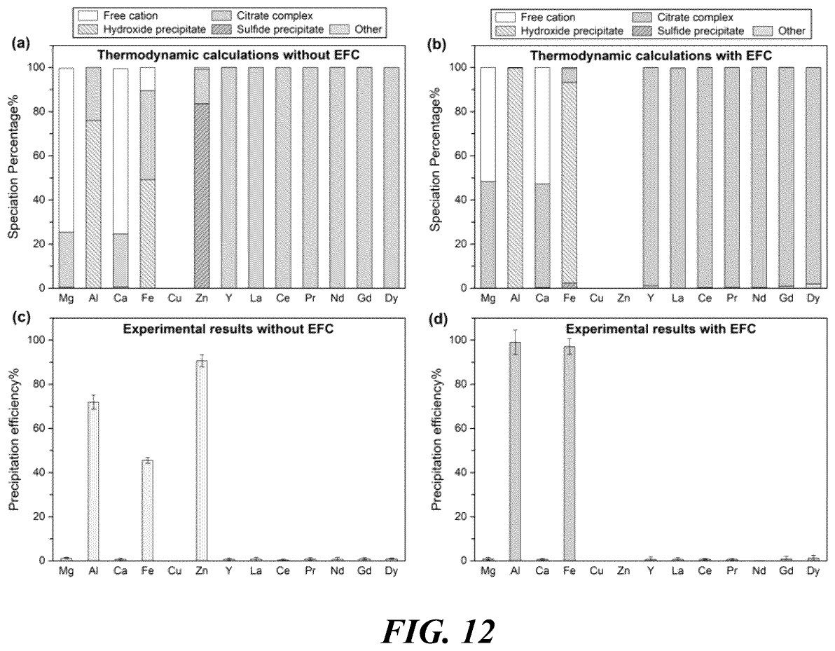

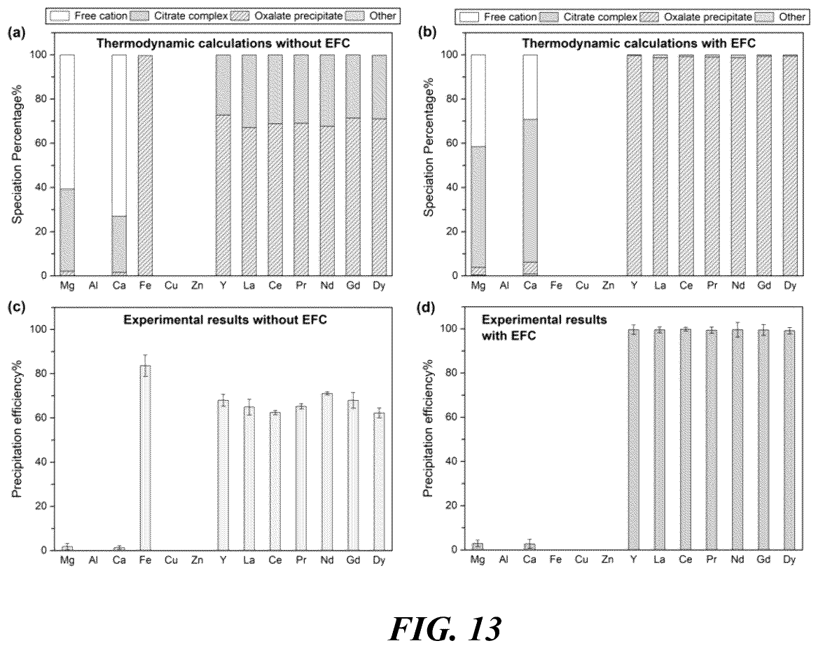

Metal pre-concentration via EFC. Prior to metal precipitation, EFC was employed to pre-concentrate metals in leachate. Note that determining the eutectic point was not a focus of this study. In a preliminary test, EFC was performed on a 200 mL simulated solution containing 10 mmol/L CaCl₂ and 10 μmol/L YCl₃ at a freezing temperature of −20° C. The solution temperature was decreased to around −4° C. within 540 min (FIG. 15, panel a). Crystallized solid phase started to form at 0° C. and steadily grew, and the total volume of solid phase eventually reached ˜212 cm³ at 540 min with only ˜21 mL of solution remained. The solution pH remained relatively stable at 4.1-4.5 (FIG. 15, panel b). Before 450 min, Ca²⁺ and Y³⁺ were well-retained in the aqueous phase (FIG. 15). After 450 min, however, the retained fractions of Ca²⁺ and Y³⁺ rapidly declined, indicating that the temperature was below the eutectic point and solutes were crystallized (FIG. 16). The similar profiles of Ca²⁺ and Y³⁺ suggested the indiscriminative concentration of solutes by EFC. Based on the preliminary results shown in FIG. 8, 450 min was the optimal reaction time, at which near 90% of Ca²⁺ and Y³⁺ were retained in the aqueous phase (Eq. 2), and their concentrations increased to more than seven-folded (Eq. 3). Note that since many organic compounds such as citric acid do not form a well-defined eutectic system like inorganic salts do, they tend to remain dissolved in water and become concentrated instead of crystallizing as solid phases.

EFC was then conducted on the real citrate leachate of MSWIA under the optimal conditions, and the corresponding characteristics of target metals in EFC concentrate were summarized in Table 1. Overall, the concentration profiles were similar to the simulated solution, with ˜88-94% of target metals retained and a concentration factor of ˜6.7-8.3. After EFC, the solution volume was reduced from 200 mL to −20 mL, and the final pH was 4.1±0.2. To determine the effect of pre-concentration, the EFC concentrate and the original leachate without EFC were both used as feedstocks for subsequent metal precipitation processes.

TABLE 1
Characteristics of target metals during EFC process.

| | Conc. in EFC | | |
|---|---|---|---|
| | concentrate | Fraction retained in | Conc. |
| Element | (mg/kg) | aqueous phase | factor |
| Mg | 308.52 | 88.37% | 7.80 |
| Al | 1467.6 | 92.01% | 7.04 |
| Ca | 5563.4 | 91.72% | 8.21 |
| Fe | 1229.9 | 89.76% | 7.85 |
| Cu | 112.54 | 90.12% | 7.27 |
| Zn | 276.25 | 87.90% | 7.44 |
| Y | 0.28 | 91.26% | 7.21 |
| La | 0.54 | 90.70% | 8.34 |
| Ce | 0.70 | 90.12% | 7.36 |
| Pr | 1.77 | 93.66% | 7.94 |
| Nd | 5.47 | 89.25% | 6.99 |
| Gd | 0.07 | 91.87% | 6.95 |
| Dy | 0.37 | 88.48% | 6.71 |
| ΣREE | 9.96 | 90.76% | 7.38 |

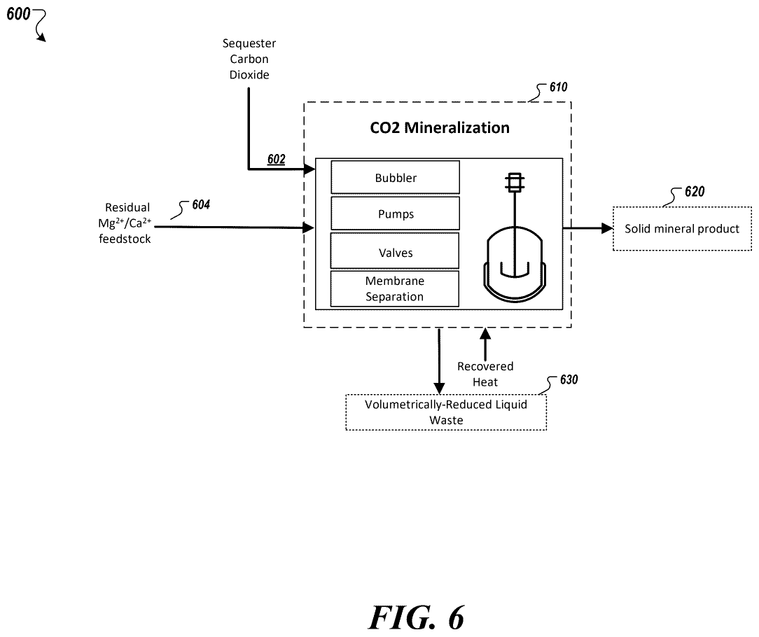

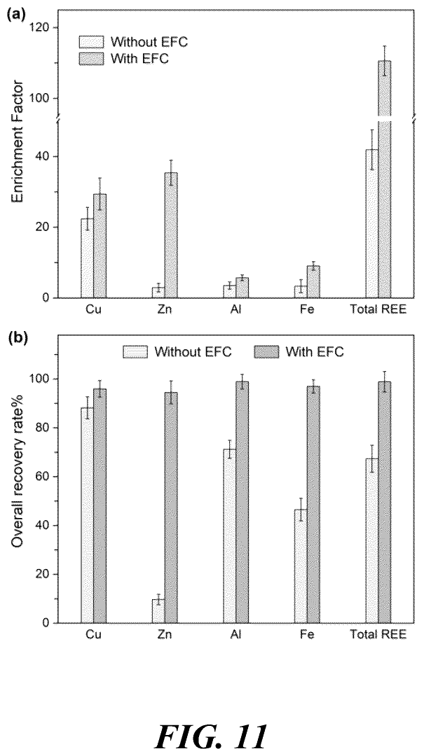

Recovery of Cu and Zn via sulfide precipitation. Sulfide precipitation is widely applied in hydrometallurgical treatment of ore leachates owing to the low solubility of certain metal sulfides, potential for selective removal, fast kinetics, and good settling properties [61]. Using sulfide could preferentially precipitate Cu²⁺ and Zn²⁺ from the leachate considering the particularly low solubility product constants (Kₛₚ) of their sulfide products (7.9×10⁻³⁷ for CuS and 2.0×10⁻²⁵ for ZnS at 25° C.) compared to other metal ions in the leachate [34]. Thermodynamic modeling using PHREEQC was first performed to predict the metal-ligand interactions once sulfide is added, with measured solution chemistry of leachate and EFC concentrate as the input (FIG. 27). The results suggested complete complexation and precipitation of Cu²⁺ with sulfide to form Cu(HS)₂⁰ for both leachate (without EFC) and EFC concentrate (with EFC) with a positive SI of 8.32 (FIG. 9, panels a-b, FIG. 14). On the other hand, 77.5% of Zn²⁺ in leachate forms soluble citrate complex Zn(C₆H₇O₇)⁺ due to the strong complexing ability between citrate and Zn²⁺ (FIG. 28), and only 15.8% complexes as Zn(HS)₂⁰. Surprisingly, however, 95.6% of Zn²⁺ in EFC concentrate precipitates as Zn(HS)₂⁰ (SI=5.59), with only ˜4% exists as free Zn²⁺. The notably enhanced Zn precipitation in EFC concentrate can be attributed to the increased concentrations of Zn²⁺ and sulfide compared to leachate, which strongly favor complexation. In addition, complexation between other metals and sulfide was predicted to be negligible, and they predominantly complex with citrate. For example, ˜99% of Fe³⁺ forms Fe(C₆H₆O₇)⁺, whereas REE form both REE(C₆H₆O₇)⁺ and REE(C₆H₅O₇)⁰ (FIG. 14). Mg²⁺ and Ca²⁺ were two exceptions that mainly exist as free cations, possibly due to the low log β⁰ of their citrate complexes (FIG. 28).

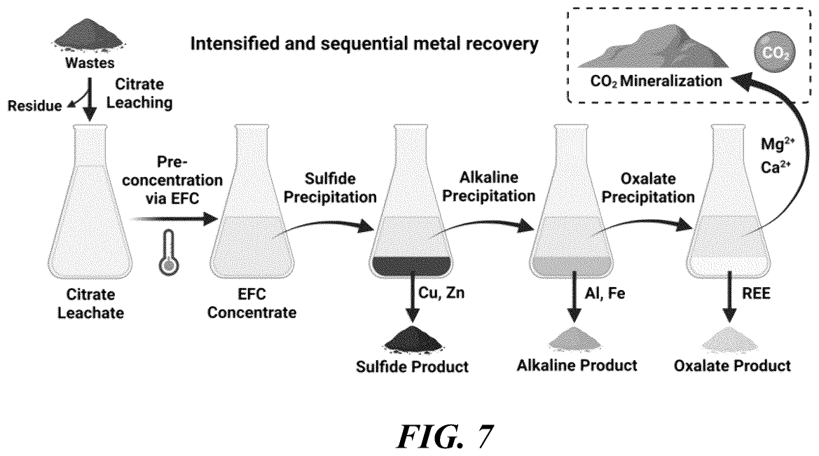

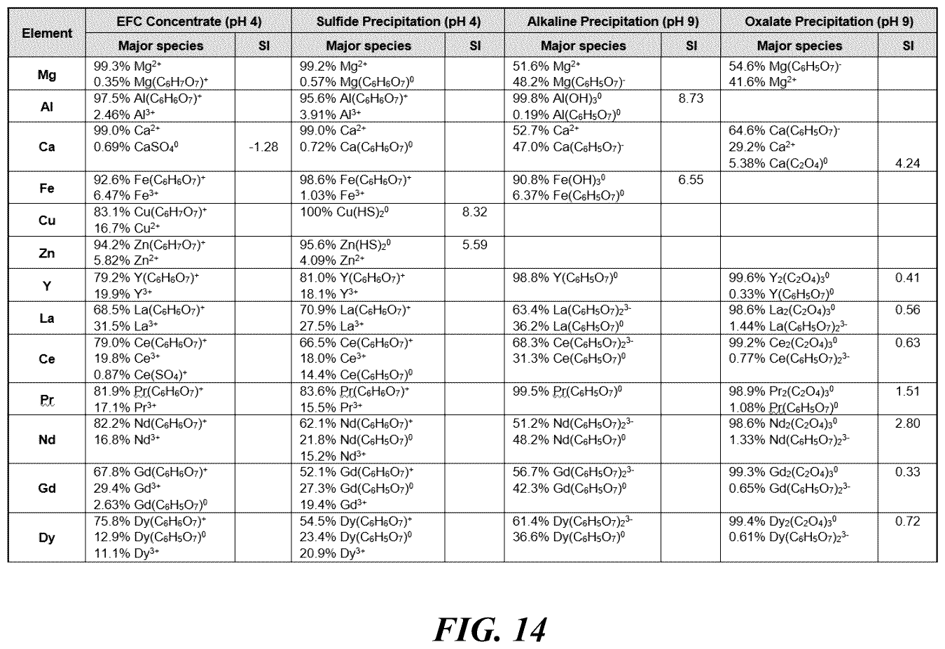

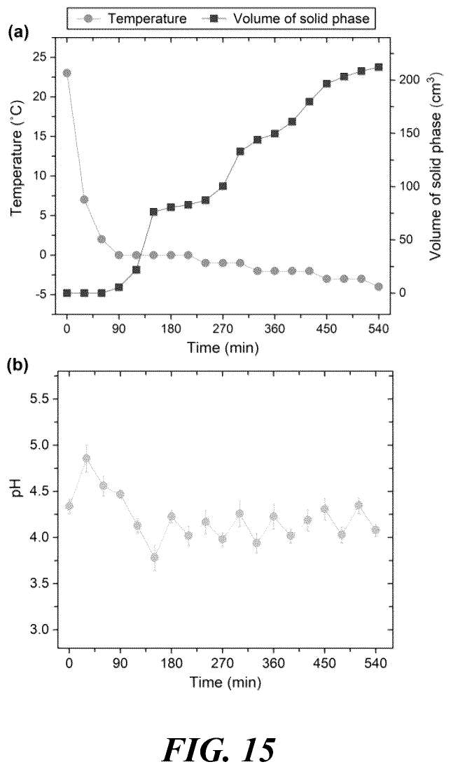

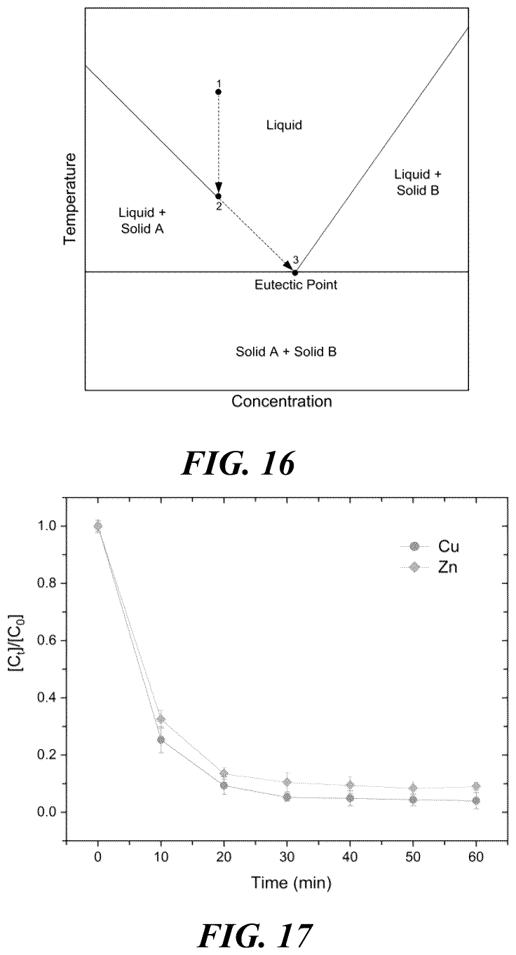

In order to confirm the modeling results, batch experiments of sulfide precipitation were performed on leachate and EFC concentrate. The reaction time of 30 min was selected based on a preliminary kinetic experiment to achieve steady state (FIG. 17). Black precipitates formed immediately after sulfide was added to the solutions. Based on XRD analysis, the sulfide product of EFC concentrate consisted of 67.5% sphalerite (ZnS) and 32.5% covellite (CuS) (FIG. 18, Table 2). The SEM image showed the growth of irregularly-shaped particles on bigger aggregates (FIG. 10, panel a, FIG. 19). The average particle size of individual sulfide particle was around 10-30 nm, and the size of aggregates typically ranged from 10-20 μm. In addition, emissions of Cu L_{α} (0.93 keV), K_{α} (8.04 keV), and K_{β} (8.91 keV) edges, Zn L_{α} (1.01 keV), K_{α} (8.63 keV), and K_{β} (9.57 keV), and S K_{α} (2.31 keV) and K_{β} (2.46 keV) edges were observed by EDX analysis (FIG. 10, panel b).

TABLE 2
Mineralogical composition of precipitation products.

| | | | |
|---|---|---|---|
| | Mineral | | |
| ICDD # | Name | Chemical Formula | Weight % |

Sulfide product

| | | | |
|---|---|---|---|
| 04-017-5722 | Sphalerite | ZnS | 67.5 |
| 04-001-1461 | Covellite | CuS | 32.5 |

Alkaline product

| | | | |
|---|---|---|---|
| 00-014-0130 | Natroalunite | NaAl₃(SO₄)₂(OH)₆ | 85.7 |
| 04-015-8377 | Jahnsite | NaMg₂Fe₃(PO₄)₄(OH)₂(H₂O)₈ | 14.3 |

Oxalate product

| | | | |
|---|---|---|---|
| 04-011-6002 | Weddellite | Ca₂(C₂O₄)₂(H₂O)_{4.4} | >99.0 |

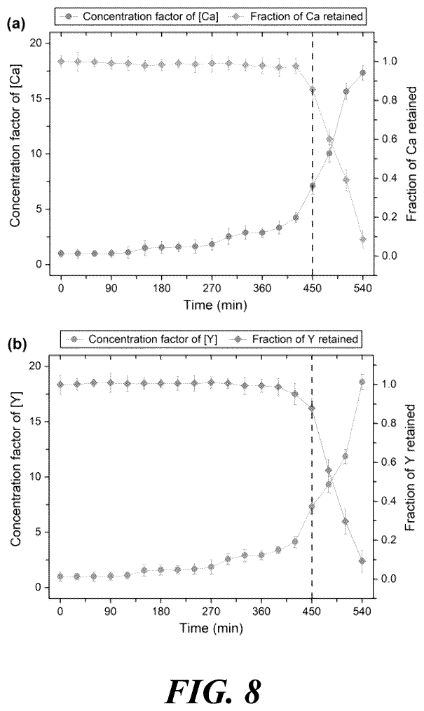

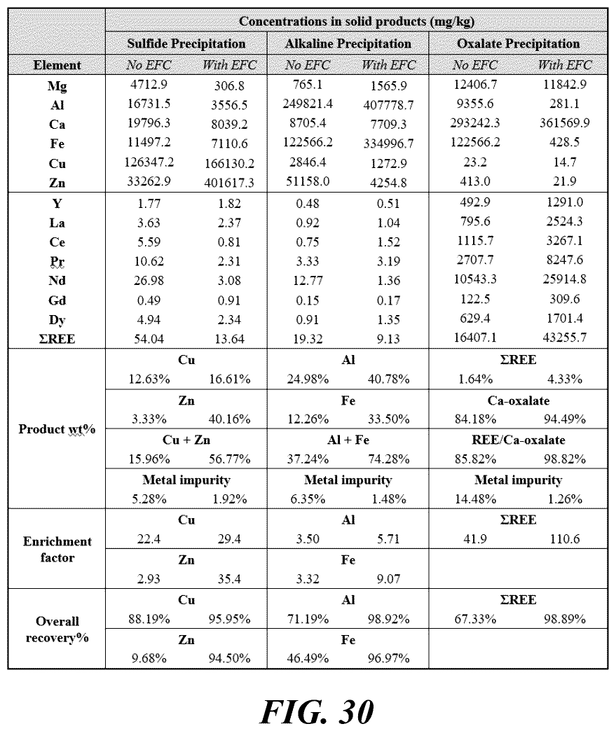

The precipitation efficiencies of Cu²⁺ and Zn²⁺ in leachate were 88.2% and 9.69%, respectively (Eq. 4) (FIG. 9, panel c), with the majority of Zn²⁺ remained in solution, whereas for EFC concentrate, 96.0% of Cu²⁺ and 90.9% of Zn²⁺ precipitated as sulfides (FIG. 9, panel d). Precipitation of other metals were negligible. Weight percentages of Cu and Zn in sulfide product of EFC concentrate reached 16.6% and 40.2% (Eq. 5), respectively, with only 1.9% of metal impurity (mostly Ca and Fe) and the remaining fraction likely as S (FIG. 30). Pre-concentration by EFC increased the enrichment factor of Cu from 22.4 to 29.4 and Zn from 2.93 to 35.4 (Eq. 6, FIG. 11, panel a). The Cu and Zn concentrations in sulfide product with pre-concentration were around 30 times higher than raw MSWIA. Furthermore, the overall recovery rates of 96.0% for Cu and 94.5% for Zn (Eq. 7) illustrated that Cu and Zn in the MSWIA sample were almost completely recovered by sulfide precipitation with a high product purity (FIG. 11, panel b). In comparison, Cu and Zn only accounted for 12.6% and 3.33% of product mass for leachate, respectively, and the metal impurity was 5.28%. Only 9.68% of Zn in MSWIA was recovered. The experimental results agreed well with thermodynamic modeling, confirming the high selectivity of sulfide precipitation towards Cu²⁺ and Zn²⁺ and enhancive effect of pre-concentration.

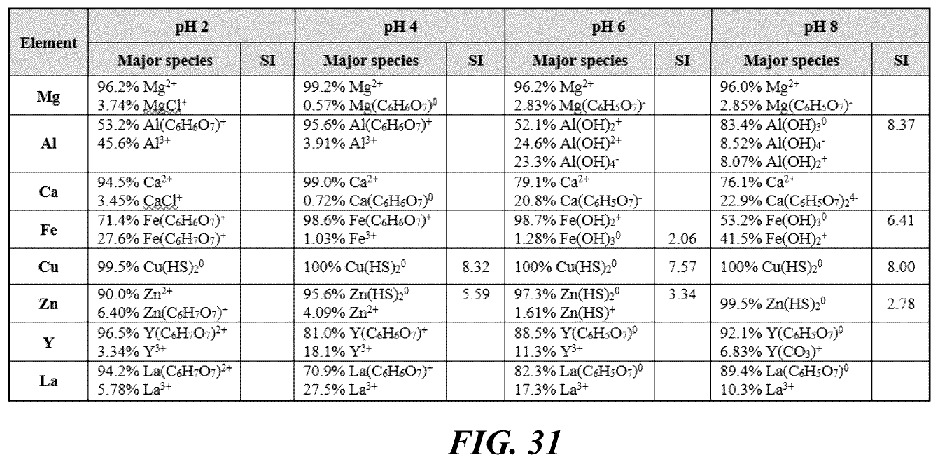

To monitor the effect of pH on each metal precipitation process, the changes in major metal speciation at different solution pH were predicted by PHREEQC and presented in FIGS. 31-33. During sulfide precipitation, the precipitation efficiency of Cu is largely unaffected from pH 2-8, while that of Zn is slightly reduced as pH decreases to 2 (FIG. 31). Hydroxide starts to outcompete citrate for Al and Fe above neutral pH and forms insoluble Al- and Fe-hydroxides at pH 8. Other metals such as Mg, Ca, and REE remain soluble, either as free cations or citrate complexes. Overall, a moderately acidic condition (pH 4-6) is suitable for selective precipitation of Cu and Zn.

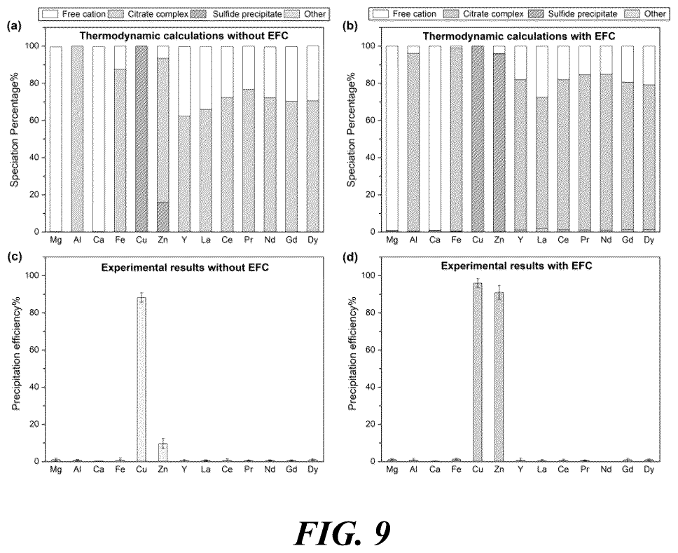

Recovery of Al and Fe via alkaline precipitation. The solubility of many metal species is pH-dependent, and they can precipitate as hydroxides under alkaline conditions, including Al³⁺, Fe³⁺, Cu²⁺, and Zn²⁺ (FIG. 28). Now that Cu²⁺ and Zn²⁺ have been mostly recovered in EFC concentrate, the second precipitation process was designed to precipitate Al³⁺ and Fe³⁺ by increasing solution pH. PHREEQC modeling predicted that at pH 9, ˜76% of Al³⁺ and ˜49% of Fe³⁺ in leachate without EFC would precipitate as hydroxides, while the remaining fractions mostly form citrate complexes (FIG. 12, panel a). Note that the majority of Zn²⁺ still remained in leachate, which would likely precipitate as ZnS as pH rises. On the other hand, for EFC concentrate, 99.8% of Al³⁺ would precipitate as Al(OH)₃⁰ (SI=8.73), and 90.8% of Fe³⁺ would precipitate as Fe(OH)₃⁰ (SI=6.55) (FIG. 14). The complexation between Al³⁺/Fe³⁺ and hydroxide anions was promoted by the higher metal concentrations in EFC concentrate. At pH 9.0, citrate is fully deprotonated as C₆H₅O₇³⁻ (pKₐ₃=6.4) [36], which forms stronger complexes with many metals than C₆H₆O₇²⁻ (FIG. 28). Hence, ˜80% of REE form citrate complexes at pH 4 [mostly as REE(C₆H₆O₇)⁺], whereas at pH 9, REE completely complex with citrate as REE(C₆H₅O₇)₂³⁻ and REE(C₆H₅O₇)⁰ (FIG. 2, panel b vs. FIG. 12, panel b).

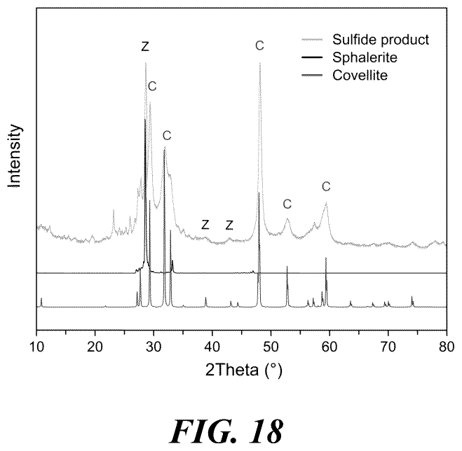

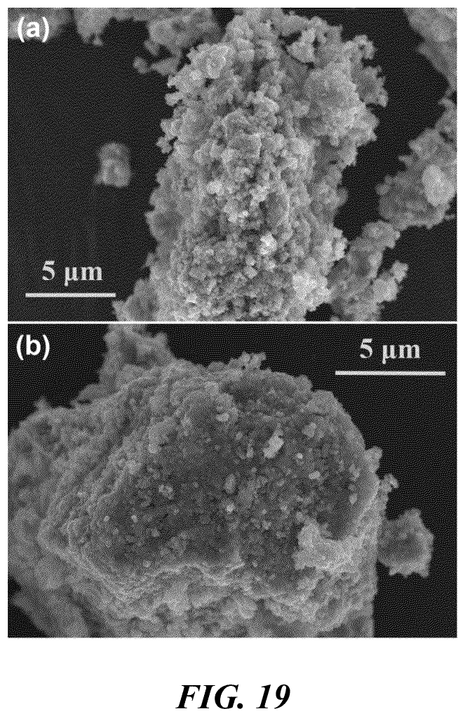

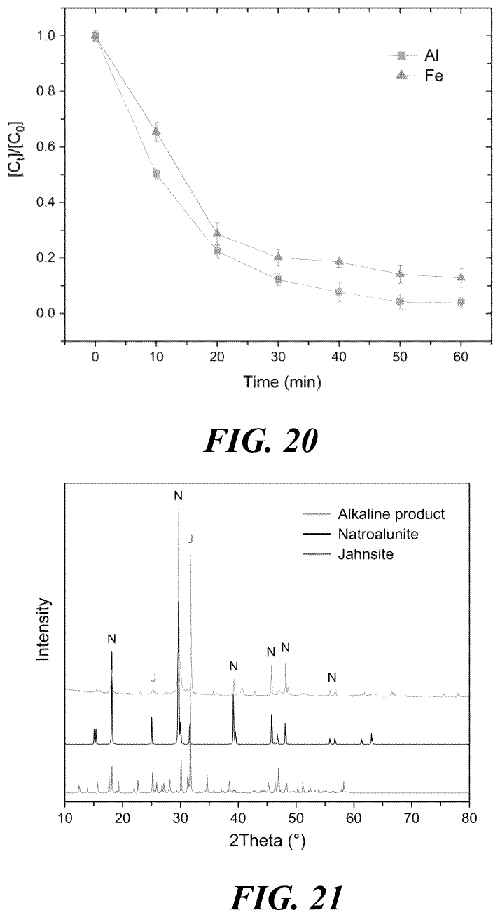

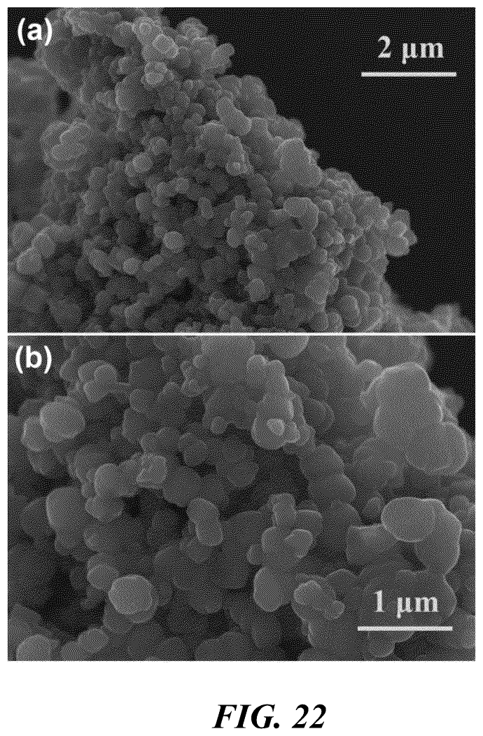

After alkaline precipitation experiment (reaction time of 60 min according to FIG. 20), yellow precipitates were collected from EFC concentrate, which were identified by XRD analysis as 85.7% of natroalunite [NaAl₃(SO₄)₂(OH)₆] and 14.3% of jahnsite [NaMg₂Fe₃(PO₄)₄(OH)₂(H₂O)₈] (FIG. 21, Table 2). SEM images revealed two types of major morphologies: round-edged particles and cubic particles (FIG. 10, panel c, FIG. 22). The round-edged particles showed an average size of ˜200 nm to 1 μm, whereas the cubic particles were around 600 nm in length. EDX spectra collected on both types of particles indicated similar elemental compositions (FIG. 10, panel d, FIG. 23). Emission of Al K_{α} (1.49 keV), Fe L_{α} (0.71 keV), K_{α} (6.40 keV), and K_{β} (7.06 keV) edges were observed.

For leachate without EFC, the measured precipitation efficiencies of Al³⁺, Fe³⁺, and Zn²⁺ were 71.9%, 45.6%, and 90.6%, respectively (FIG. 12, panel c). The wt % of Al and Fe in the alkaline product were 25.0% and 12.3%, respectively, with an enrichment factor of ˜3 (FIG. 30). Co-precipitation of ZnS led a higher metal impurity, and only 71.2% of Al and 46.5% of Fe in MSWIA were recovered (FIG. 11, panel b). In contrast, precipitation of Al³⁺ (99.0%) and Fe³⁺ (97.1%) was highly effective for EFC concentrate (FIG. 12, panel d). Al and Fe constituted 40.8% and 33.5% of product, respectively, with only ˜1.5% of metal impurity (FIG. 30). The overall recovery rates of Al and Fe reached 98.9% and 97.0%, and corresponding enrichment factors were 5.71 and 9.07, respectively (FIG. 11). The experimental results of both solutions matched well with thermodynamic modeling. The effective removal of Cu²⁺ and Zn²⁺ from EFC concentrate via sulfide precipitation contributed to a higher Al and Fe purity in alkaline product.

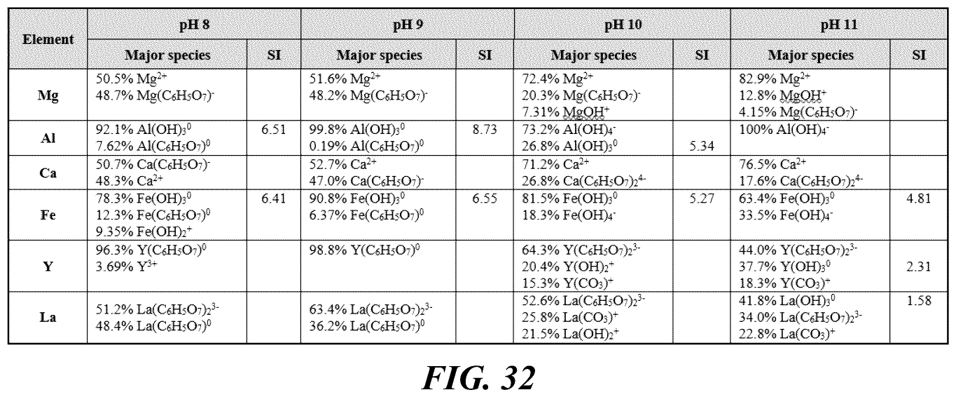

As shown in FIG. 32, the precipitation efficiency of Al and Fe reaches the maximum at pH 9 and starts to drop as pH further increases due to the formation of soluble hydroxide complexes such as Al(OH)₄⁻ and Fe(OH)₄⁻. On the other hand, complexations between REE and hydroxide and carbonate become dominant as pH reaches 11, and REE start to precipitate as hydroxides. This indicates that pH 9 is a suitable pH for the selective precipitation of Al and Fe.

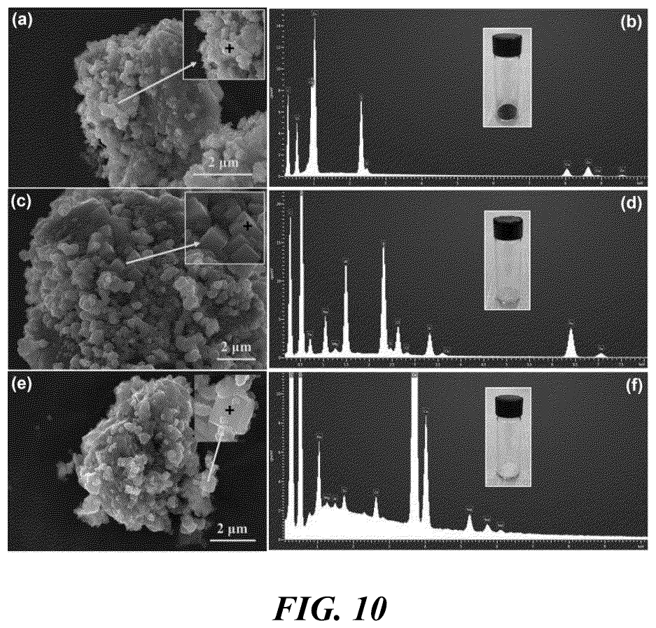

Recovery of REE via oxalate precipitation. It has been inferred that co-precipitation of REE with Ca-oxalate (Kₛₚ=1.7×10⁻⁹ at 25° C.) via substitution is thermodynamically and kinetically favorable because of the similar ionic radii of Ca²⁺ (1.12 Å) and REE³⁺ (˜0.99 to 1.16 Å) with an 8-fold coordination, high reaction equilibrium constant, and fast kinetics, and thus it is particularly suitable for REE recovery from Ca-rich feedstocks [12, 14, 62-64]. In this study, oxalate precipitation was designed as the last step to selectively recover REE. Since oxalate can form insoluble complexes with many metals including Al, Fe, Cu, and Zn (FIG. 28) [65], the prior two precipitation processes were performed to remove these metals first and to minimize the impurity in oxalate product. Based on thermodynamic modeling, ˜70% of REE in leachate without EFC would co-precipitate with Ca-oxalate, and the remaining 30% complex with citrate (FIG. 13, panel a). The Fe³⁺ that was not removed by alkaline precipitation would form insoluble Fe₂(C₂O₄)⁰ (SI=0.87). For EFC concentrate, however, ˜100% of REE would complex with oxalate to form insoluble REE₂(C₂O₄)₃⁰, with a positive SI of 0.33-2.80 (FIG. 13, panel b, FIG. 14). REE-oxalate complexes have high log β⁰ ranging from 5.9-6.8 for monodentate and 10.5-11.4 for bidentate complexes (FIG. 28). Around 5% of Ca²⁺ was predicted to precipitate as Ca(C₂O₄)⁰ (SI=4.24), which would be enough to co-precipitate REE considering the significantly higher Ca²⁺ concentration compared to REE (FIG. 14). In addition, 64.6% of Ca²⁺ would form Ca(C₆H₅O₇)⁻, while the remaining 29.2% exists as free Ca²⁺.

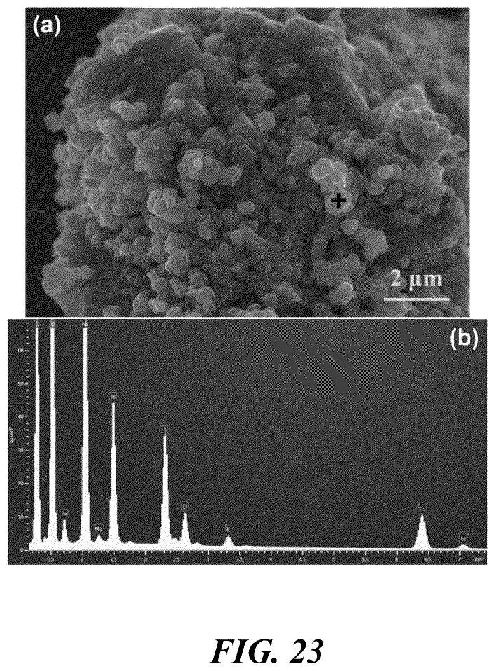

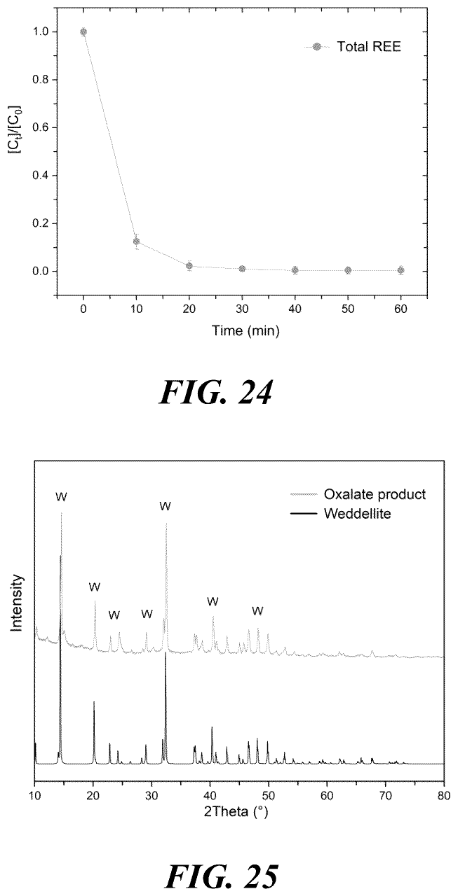

Preliminary results indicated that REE rapidly precipitated as white precipitates within 20 min (FIG. 24). The XRD pattern illustrates that oxalate product of EFC concentrate contained predominantly (>99%) weddellite [Ca(C₂O₄)₂·2H₂O] (FIG. 25, Table 2). The weddellite particles appeared as near-rhombic shaped, though most of the particles did not have well-defined shapes or edges, probably due to incomplete nucleation and crystal growth within a short reaction time (FIG. 10, panel e). The average size of rhombic-shaped individual weddellite particle was around 200-500 nm. The strong emission peaks of Ca K_{α} (3.69 keV) and K_{β} (4.01 keV) edges can be clearly observed from the EDX spectra, as well as the L_{α} (5.23 keV), L_{β1} (5.72 keV), and L_{β2} (6.09 keV) edges of Nd, the most concentrated REE (FIG. 10, panel f).

The metal precipitation efficiencies followed a consistent pattern with the modeling results. Without EFC, 83.6% of Fe³⁺ and 68.2% of total REE in leachate precipitated (FIG. 13, panel c). The weight percentage of total REE in oxalate product was 1.64% (FIG. 30). Ca-oxalate accounted for 84.2% of product mass, and co-precipitation of Fe³⁺ was responsible for a 12.3% of metal impurity. Around 67% of total REE was recovered from MSWIA, with an enrichment factor of ˜40. For EFC concentrate, however, precipitation efficiencies of all seven REE were notably increased to >99%, along with ˜3% precipitation of Ca²⁺ (FIG. 13, panel d). The oxalate product contained 4.33 wt % of total REE and 94.5 wt % of Ca-oxalate, with only 1.26 wt % of metal impurity (FIG. 30). The wt % of Nd as the most concentrated REE in the oxalate product reached ˜2.6%. About 99% of total REE from MSWIA was recovered, and significantly, the total REE concentration in oxalate product (43,255 mg/kg) was ˜110 times higher than raw MSWIA (390 mg/kg) and more than double of the oxalate product from leachate without EFC (16,407 mg/kg) (FIG. 11). The oxalate product of EFC concentrate contained almost purely of REE and Ca-oxalate, which can be either dissolved in acids or calcined to product REE/Ca-oxides. REE and Ca can be easily separated (e.g., ion exchange, solvent extraction), and oxalate can be recycled to reduce costs.

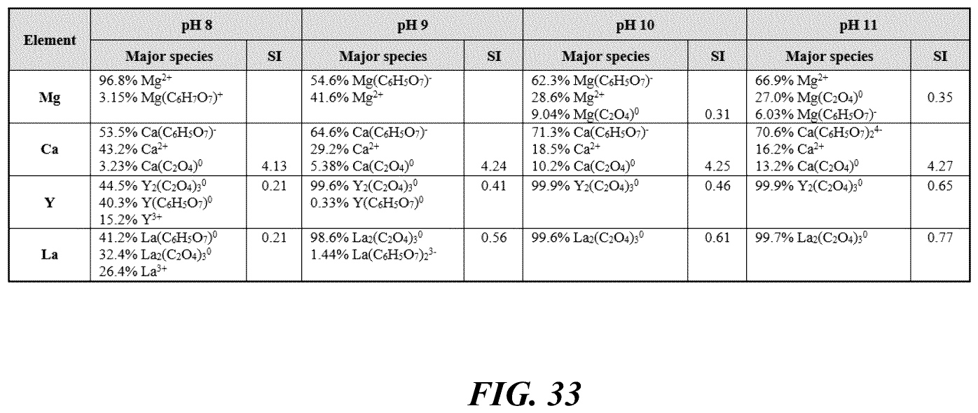

As pH increases from 8 to 11, the precipitation efficiencies of REE remained unaffected because they are already near complete (FIG. 33). However, precipitation of Ca as oxalate steadily increases, and ˜30% of Mg precipitates as oxalate at pH 11. Hence, pH 8 allows effectively recovery of REE while minimizing the amount of Ca and Mg as impurities in the oxalate product.

Impacts of organic acids vs. mineral acids on metal precipitation. The presence of leaching ligands in leachate could still interact with metal cations and compete with precipitating ligands, yet their potential impacts on subsequent metal precipitation processes have been largely overlooked. As is shown in FIG. 14, metals in EFC concentrate are predominantly complexed with citrate (except Mg and Ca), including 83.1% Cu as Cu(C₆H₇O₇)⁺ and 94.2% Zn as Zn(C₆H₇O₇)⁺. During sulfide precipitation, sulfide outcompetes citrate for Cu and Zn and forms insoluble sulfide complexes due to higher log β⁰ [e.g., 17.3 for Cu(HS)₂⁰ vs. 13.2 for Cu(C₆H₇O₇)⁺, FIG. 28], whereas other metals mostly remain as citrate complexes. Similarly, as pH increases during alkaline precipitation, formation of insoluble Al(OH)₃⁰ and Fe(OH)₃⁰ becomes thermodynamically more favorable than Al(C₆H₅O₇)⁰ and Fe(C₆H₅O₇)⁰. The strong complexing ability of citrate with REE [log β⁰ of 9.4-10.4 for REE(C₆H₅O₇)⁰ and REE(C₆H₅O₇)₂³⁻] prevents them from complexing with sulfide and hydroxide (log β⁰ of ˜3.8-8.2) until they form stronger oxalate complexes [log β⁰ of 10.7-12.9 for REE₂(C₂O₄)₃⁰] in the last step. These results revealed that presence of citrate serves as a protecting ligand for certain metals and played a prominant role in sequential metal recovery in this method.

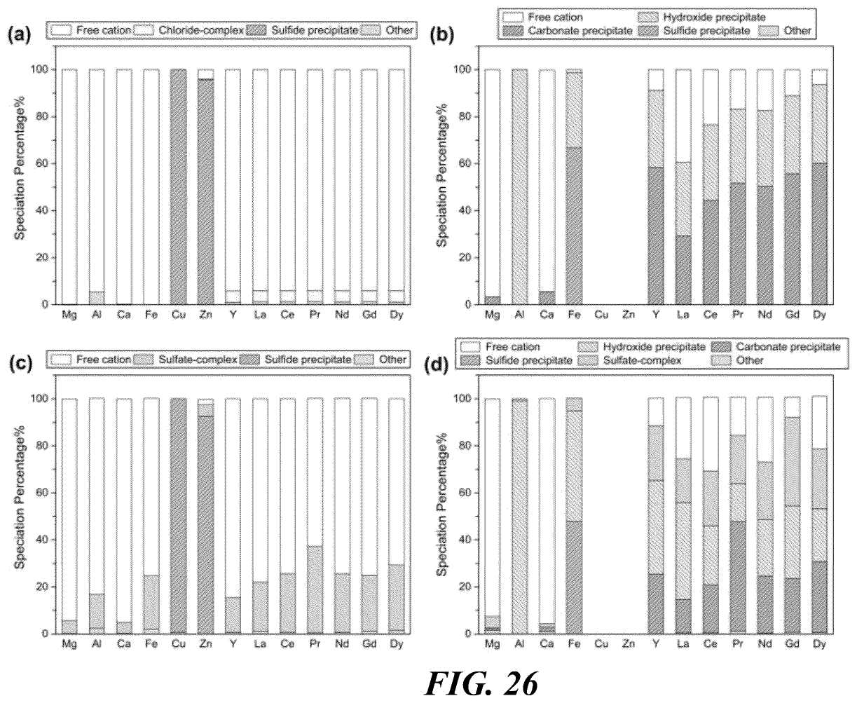

In comparison, thermodynamic modeling was also performed to examine the metal-ligand interaction during precipitation processes under the same condition (assuming similar solution chemistry as the citrate EFC concentrate) using HCl or H₂SO₄ as the leaching agent, both of which are commonly used in hydrometallurgy but have weaker metal complexing ability than citrate (FIG. 28). With HCl, near-complete precipitation of Cu²⁺ and Zn²⁺ can be achieved during sulfide precipitation (FIG. 26, panel a). However, other target metals are predominantly present as free cations owing to the weak complexing ability of Cl⁻ (log β⁰ of −0.89-2.13, FIG. 28). Consequently, hydroxide and carbonate dominate REE complexation (log β⁰ of 2.32-12.9) as pH increases during alkaline precipitation, resulting in undesired co-precipitation of REE-hydroxides/carbonates mixed with Al-hydroxide and Fe-hydroxide/sulfide (FIG. 26, panel b). Similar results are predicted for H₂SO₄, except for the lower REE precipitation rates during alkaline precipitation (FIG. 26, panels c-d). This is likely due to the slightly stronger complexing ability of SO₄²⁻ (log β⁰ of 3.48-5.20), which protects REE more effectively than Cl⁻. In addition, phosphate is another inorganic ligand present in the leachate that could form insoluble complexes with many metals such as Ca, Fe, and Zn. However, formation of metal-phosphate complexes is thermodynamically less favorable than that of other metal-ligand complexes involved in each precipitation process (e.g., Cu-/Zn-sulfide, Al-/Fe-hydroxide, REE-oxalate) (FIG. 28). The modeling results showed that the influence of phosphate on selective metal precipitation in this system is negligible.

From an economic perspective, the unit price of citric acid on the global market (˜$600-900 per metric ton) is higher than those of other mineral acids such as HCl, H₂SO₄, and HNO₃ (˜$100-300 per metric ton) that are commonly used in conventional hydrometallurgy. However, a much lower chemical input is required for citric acid (50 mmol/L in this study) to achieve a similar leaching efficiency with mineral acids (typically ˜1-5 mol/L) owing to its strong metal-complexing abilities [66, 67]. Further efforts are needed to evaluate the technoeconomic feasibility and life-cycle-impacts of using organic acids in REE recovery as compared to mineral acids.

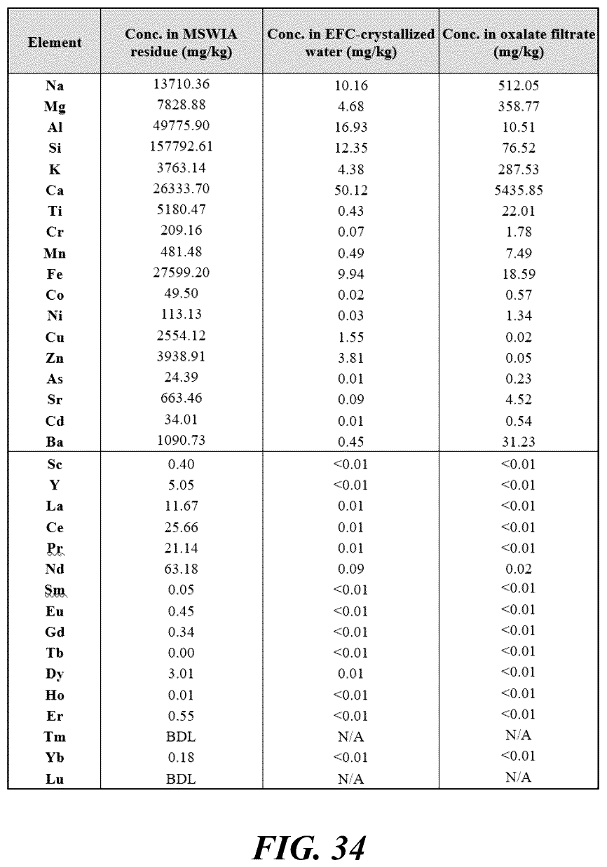

Utilization and post-treatment of byproducts. In addition to the recovered metal products, this treatment method also produces three byproducts: MSWIA residue, EFC-crystallized water, and oxalate filtrate (FIG. 7). The MSWIA residue was still rich in Na, Mg, Al, Si, and Ca (FIG. 34), and can be used to synthesize zeolite, which can immobilize heavy metals in MSWIA and serve as a less-hazardous alternative for waste storage/disposal [12]. The EFC-crystallized water was relatively “clean” and thus can be either discharged as wastewater or reused after simple treatments (FIG. 34). The few metals with notable concentrations (˜1-50 mg/kg) in the crystallized water can be easily removed by conventional water treatment processes. For example, Mg²⁺ and Ca²⁺ can be removed by softening processes (e.g., ion exchange, lime-soda precipitation), whereas Al³⁺, Fe³⁺, Cu²⁺, and Zn²⁺ can be removed via coagulation and flocculation.

Since the oxalate filtrate contained particularly high concentrations of Mg²⁺ and Ca²⁺ (FIG. 34), it can be considered as a potential feedstock for CO₂ mineralization similarly to desalination brines [68]. Mg²⁺ and Ca²⁺ can react with bicarbonate/carbonate speciated from dissolved CO₂ to produce insoluble carbonate minerals with a reaction rate constant of >10⁶ M⁻¹·s⁻¹ [69]. Based on reaction stoichiometry and assuming a 90% extent of reaction, oxalate filtrate produced from 1 g of MSWIA can sequester 0.27 g of CO₂, and thus a total of ˜2.1 million tons of CO₂ can be sequestered if all 8 million tons of annually produced MSWIA in the U.S. is recycled using this method, which requires further studies to confirm [70].

Environmental Implications. In this study, a feasible strategy for intensified and sequential recovery of REE and four other valuable metals from leachate of an incineration byproduct using combined physical concentration and sequential chemical precipitation processes was demonstrated. This modular process is widely applicable not only to MSWIA, but also other feedstocks containing these target metals (e.g., coal ash, mine tailings, electronic wastes). The effectiveness and feasibility of this process were substantiated by experimental data and thermodynamic modeling results. EFC as an example of pre-concentration method remarkably improved the precipitation efficiency, product purity, and overall recovery rate of target metals. A ten-fold reduction in leachate volume is also favorable for downstream processing. According to thermodynamic modeling, the enhancive effect of pre-concentration can be mainly ascribed to the enhanced metal-ligand complexation between target metals and precipitating ligands at a much higher solute concentration. The energy consumption of EFC can be further reduced or even completely offset if climate-driven refrigeration can be utilized [29]. Continuously stirred reactors or continuously flowing pipelines can be installed in cold regions to allow spontaneous crystallization of water and constant mobilization and removal of floating ice phase. Note that pre-concentration can also be achieved using other techniques (e.g., forward osmosis membrane) [71], but corresponding energy consumption and effectiveness need to be evaluated.

Although organic acids have been studied as greener alternatives to mineral acids in hydrometallurgical processes owing to the ligand-promoted dissolution mechanism, previous studies considered them solely as leaching agents [72-74]. Comparisons between organic and mineral acids have been mainly focused on their metal leaching efficiency [75, 76], but their influence on subsequent metal separation processes (especially chemical precipitation) has been overlooked. The results showed that presence of citrate in leachate strongly governs metal-ligand complexation during metal precipitation processes and their selectivity/efficiency. Mineral acids with weak metal complexing ability tend to have minor impacts on metal-ligand interactions and thus are not ideal for selective metal recovery via chemical precipitation, whereas organic ligands with strong metal complexing ability can prevent premature precipitation of target metals and allow effective precipitation at the designated step. A suitable organic ligand can serve as both a leaching agent for metal extraction as well as protecting agent during metal precipitation, which is crucial for selective metal recovery. This study exemplifies the feasibility of an organic ligand-based treatment method for sequential recovery of multiple critical metals. To date, the performance of mineral and organic acids in hydrometallurgy is still controversial, and our results suggested that future evaluation needs to consider the influence of these ligands on the overall metal recovery process instead of solely on metal extraction.

In some embodiments, metals from solid residues are extracted using citric acid as the leaching agent. Citric acid is a non-hazardous, bio-degradable, and weak organic acid that effectively releases metals from the feedstocks by forming metal-ligand complexes. The use of citric acid reduces chemical consumption and avoids generation of hazardous byproducts (e.g., extremely acidic wastewater and toxic gases).

In some embodiments, EFC, an energy-efficient technique that simultaneously crystallizes ice and salts, can be used as a pre-treatment step to concentrate metals in the leachate, and more importantly, we found that higher metal concentrations can enhance the metal separation efficiency of subsequent precipitation steps.

In some embodiments, precipitation of Cu and Zn as sulfides is thermodynamically favorable and rapid due to pre-concentration by EFC and does not require pH adjustment.

In some embodiments, the use of citric acid forms stable metal-citrate complexation, which prevents precipitation of non-target metals and only precipitates target metals during each step. With Cu and Zn separated from the previous step, the solid product in this step can contain a high Al and Fe purity.

In some embodiments, oxalate is added to rapidly precipitate with abundant Ca2+ in the leachate. REE with similar ionic radii to Ca2+(0.99-1.16 &Aring; vs. 1.12 &Aring;) readily co-precipitate with calcium oxalate via substitution, while other metals with much smaller ionic radii (0.53-0.75 &Aring;) remain in the solution. Instead of REE-oxalates, the example embodiment targets the formation of calcium oxalate, which is thermodynamically favorable and highly insoluble, and subsequent coprecipitation of REE.

In some embodiments, the treatment process produces three purified solid products: Cu and Zn as sulfides, Al and Fe as hydroxides, and REE as oxalates, which can be further separated and purified. The high purity of target metals in these solid products can make it easier for downstream processing and reduce the overall cost.

Embodiments of the present disclosure include improvements to methods and systems for refining rare earth elements from coal ash deposits. Optionally, embodiments of the present disclosure can be applied to CFA and MSWIA. CFA can include approximately 500 ppm rare earth elements, while MSWIA can include approximately 200 ppm REE. Embodiments of the present disclosure can include efficient ways of extracting the REE present in CFA and MSWIA.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The following patents, applications and publications as listed below and throughout this document are hereby incorporated by reference in their entirety herein.
[1] H. Prommer, Towards sustainable rare-earth-element mining, Nature Sustainability 6(1) (2023) 13-14.
[2] R. Pell, L. Tijsseling, K. Goodenough, F. Wall, Q. Dehaine, A. Grant, D. Deak, X. Yan, P. Whattoff, Towards sustainable extraction of technology materials through integrated approaches, Nature Reviews Earth & Environment 2(10) (2021) 665-679.
[3] X. Du, T. E. Graedel, Global in-use stocks of the rare earth elements: a first estimate, Environmental Science & Technology 45(9) (2011) 4096-4101.
[4] S. Massari, M. Ruberti, Rare earth elements as critical raw materials: Focus on international markets and future strategies, Resources Policy 38(1) (2013) 36-43.
[5] D. H. Dang, K. A. Thompson, L. Ma, H. Q. Nguyen, S. T. Luu, M. T. N. Duong, A. Kernaghan, Toward the circular economy of Rare Earth Elements: a review of abundance, extraction, applications, and environmental impacts, Archives of Environmental Contamination and Toxicology 81(4) (2021) 521-530.
[6] F. Xie, T. A. Zhang, D. Dreisinger, F. Doyle, A critical review on solvent extraction of rare earths from aqueous solutions, Minerals Engineering 56 (2014) 10-28.
[7] G. J.-P. Deblonde, A. Chagnes, G. Cote, Recent advances in the chemistry of hydrometallurgical methods, Separation & Purification Reviews 52(3) (2023) 221-241.
[8] E. Vahidi, F. Zhao, Environmental life cycle assessment on the separation of rare earth oxides through solvent extraction, Journal of Environmental Management 203 (2017) 255-263.
[9] J. C. Lee, Z. Wen, Pathways for greening the supply of rare earth elements in China, Nature Sustainability 1(10) (2018) 598-605.
[10] A. Amato, A. Becci, I. Birloaga, I. De Michelis, F. Ferella, V. Innocenzi, N. M. Ippolito, C. P. J. Gomez, F. Veglib, F. Beolchini, Sustainability analysis of innovative technologies for the rare earth elements recovery, Renewable and Sustainable Energy Reviews 106 (2019) 41-53.
[11]R. K. Jyothi, T. Thenepalli, J. W. Ahn, P. K. Parhi, K. W. Chung, J.-Y. Lee, Review of rare earth elements recovery from secondary resources for clean energy technologies: Grand opportunities to create wealth from waste, Journal of Cleaner Production 267 (2020) 122048.
[12] Y. Wen, Hu, L., Boxleiter, A., Li, D., Tang, Y., Rare earth elements recovery and waste management of municipal solid waste incineration ash, ACS Sustainable Resource Management 1(1) (2023) 17-27.
[13] S. M. Jowitt, T. T. Werner, Z. Weng, G. M. Mudd, Recycling of the rare earth elements, Current Opinion in Green and Sustainable Chemistry 13 (2018) 1-7.
[14] P. Liu, S. Zhao, N. Xie, L. Yang, Q. Wang, Y. Wen, H. Chen, Y. Tang, Green Approach for Rare Earth Element (REE) Recovery from Coal Fly Ash, Environmental Science & Technology 57(13) (2023) 5414-5423.
[15] F. Zhou, Y. Xiao, M. Guo, Y. Tang, W. Zhang, R. Qiu, Selective leaching of rare earth elements from ion-adsorption rare earth tailings: a synergy between CeO₂ reduction and Fe/Mn stabilization, Environmental Science & Technology 55(16) (2021) 11328-11337.
[16] Q. Tan, J. Li, X. Zeng, Rare earth elements recovery from waste fluorescent lamps: a review, Critical Reviews in Environmental Science and Technology 45(7) (2015) 749-776.
[17] C. Liu, Q. Yan, X. Zhang, L. Lei, C. Xiao, Efficient recovery of end-of-life NdFeB permanent magnets by selective leaching with deep eutectic solvents, Environmental Science & Technology 54(16) (2020) 10370-10379.
[18] V. G. Deshmane, S. Z. Islam, R. R. Bhave, Selective recovery of rare earth elements from a wide range of e-waste and process scalability of membrane solvent extraction, Environmental Science & Technology 54(1) (2019) 550-558.
[19] L. Stoy, V. Diaz, C.-H. Huang, Preferential recovery of rare-earth elements from coal fly ash using a recyclable ionic liquid, Environmental Science & Technology 55(13) (2021) 9209-9220.
[20] A. Ding, C. Liu, X. Zhang, L. Lei, C. Xiao, ZnCl2: a green brønsted acid for selectively recovering rare earth elements from spent NdFeB permanent magnets, Environmental Science & Technology 56(7) (2022) 4404-4412.
[21] R. C. Smith, R. K. Taggart, J. C. Hower, M. R. Wiesner, H. Hsu-Kim, Selective recovery of rare earth elements from coal fly ash leachates using liquid membrane processes, Environmental Science & Technology 53(8) (2019) 4490-4499.
[22] Y. Zhang, J. Yan, J. Xu, C. Tian, K. Matyjaszewski, R. D. Tilton, G. V. Lowry, Phosphate polymer nanogel for selective and efficient rare earth element recovery, Environmental Science & Technology 55(18) (2021) 12549-12560.
[23] L. N. Viana, A. P. S. Soares, D. L. Guimaries, W. J. S. Rojano, T. D. Saint'Pierre, Fluorescent lamps: A review on environmental concerns and current recycling perspectives highlighting Hg and rare earth elements, Journal of Environmental Chemical Engineering 10(6) (2022) 108915.
[24] R. Eggert, C. Wadia, C. Anderson, D. Bauer, F. Fields, L. Meinert, P. Taylor, Rare earths: market disruption, innovation, and global supply chains, Annual Review of Environment and Resources 41 (2016) 199-222.
[25] P. Liu, R. Huang, Y. Tang, Comprehensive understandings of rare earth element (REE) speciation in coal fly ashes and implication for REE extractability, Environmental Science & Technology 53(9) (2019) 5369-5377.
[26] F. Xu, S. Qin, S. Li, J. Wang, Q. Lu, J. Xing, Distribution, occurrence mode, and extraction potential of critical elements in coal ashes of the Chongqing Power Plant, Journal of Cleaner Production 342 (2022) 130910.
[27] B. Fu, J. C. Hower, W. Zhang, G. Luo, H. Hu, H. Yao, A review of rare earth elements and yttrium in coal ash: Content, modes of occurrences, combustion behavior, and extraction methods, Progress in Energy and Combustion Science 88 (2022) 100954.
[28] D. Randall, J. Nathoo, A. Lewis, A case study for treating a reverse osmosis brine using Eutectic Freeze Crystallization-Approaching a zero waste process, Desalination 266(1-3) (2011) 256-262.
[29] G. Kolliopoulos, C. Xu, J. T. Martin, N. Devaere, V. G. Papangelakis, Hybrid forward osmosis-freeze concentration: A promising future in the desalination of effluents in cold regions, Journal of Water Process Engineering 47 (2022) 102711.
[30] F. Wu, X. Liu, G. Qu, P. Ning, A critical review on extraction of valuable metals from solid waste, Separation and Purification Technology (2022) 122043.
[31]S. Wu, L. Wang, L. Zhao, P. Zhang, H. El-Shall, B. Moudgil, X. Huang, L. Zhang, Recovery of rare earth elements from phosphate rock by hydrometallurgical processes-A critical review, Chemical Engineering Journal 335 (2018) 774-800.
[32] B. Deng, X. Wang, D. X. Luong, R. A. Carter, Z. Wang, M. B. Tomson, J. M. Tour, Rare earth elements from waste, Science Advances 8(6) (2022) eabm3132.
[33] G. Furrer, W. Stumm, The coordination chemistry of weathering: I. Dissolution kinetics of δ-Al₂O₃ and BeO, Geochimica et Cosmochimica Acta 50(9) (1986) 1847-1860.
[34] NIST Critically Selected Stability Constants of Metal Complexes: Version 8.0, NIST, 2004.
[35] Y. Wen, P. Liu, Q. Wang, S. Zhao, Y. Tang, Organic Ligand-Mediated Dissolution and Fractionation of Rare-Earth Elements (REEs) from Carbonate and Phosphate Minerals, ACS Earth and Space Chemistry (2024).
[36] K. Burdzy, A. Aurich, S. Hunger, R. Jastrząb, M. Zabiszak, D. Kolodyńska, Green citric acid in the sorption process of rare earth elements, Chemical Engineering Journal 437 (2022) 135366.
[37] J. Pan, B. V. Hassas, M. Rezaee, C. Zhou, S. V. Pisupati, Recovery of rare earth elements from coal fly ash through sequential chemical roasting, water leaching, and acid leaching processes, Journal of Cleaner Production 284 (2021) 124725.
[38] B. V. Hassas, Y. Shekarian, M. Rezaee, Selective precipitation of rare earth and critical elements from acid mine drainage-Part I: Kinetics and thermodynamics of staged precipitation process, Resources, Conservation and Recycling 188 (2023) 106654.
[39] P. Liu, Q. Wang, H. Jung, Y. Tang, Speciation, Distribution, and Mobility of Hazardous Trace Elements in Coal Fly Ash: Insights from Cr, Ni, and Cu, Energy Fuels 34(11) (2020) 14333-14343.
[40] P. Liu, L. F. Yang, Q. Wang, B. Wan, Q. Ma, H. L. Chen, Y. Z. Tang, Speciation transformation of rare earth elements (REEs) during heating and implications for REE behaviors during coal combustion, International Journal of Coal Geology 219 (2020).
[41] E. Garcia, P. Liu, S. E. Bone, Y. Wen, Y. Tang, Systematic characterization of selenium speciation in coal fly ash, Environmental Science: Processes & Impacts 26(12) (2024) 2240-2249.
[42] E. Garcia, P. Liu, J. Sanchez, S. Lee, Q. Wang, Y. Wen, S. Shivaprakash, S. Burns, Y. Tang, A survey study on arsenic speciation in coal fly ash and insights into the role of coal combustion conditions, Appl. Geochem. 170 (2024) 106095.
[43] Y. Wen, L. Hu, P. Liu, Q. Wang, E. Garcia, W. Yan, Y. Tang, Rare earth element (REE) speciation in municipal solid waste incineration ash, Applied Geochemistry 178 (2025) 106239.
[44] Y. Wen, P. Liu, Q. Wang, S. Zhao, Y. Tang, Organic Ligand-Mediated Dissolution and Fractionation of Rare-Earth Elements (REEs) from Carbonate and Phosphate Minerals, ACS Earth and Space Chemistry 8(5) (2024) 1048-1061.
[45] H. Waki, J. Fritz, The effect of organic solvents on complexes and ion exchange-II nitrate complexes of some divalent metals in isopropyl alcohol, Journal of Inorganic and Nuclear Chemistry 28(2) (1966) 577-589.
[46] B. Mountain, T. M. Seward, Hydrosulfide/sulfide complexes of copper (I): experimental confirmation of the stoichiometry and stability of Cu(HS)₂⁻ to elevated temperatures, Geochimica et Cosmochimica Acta 67(16) (2003) 3005-3014.
[47]J. P. Larentzos, L. J. Criscenti, A molecular dynamics study of alkaline earth metal-chloride complexation in aqueous solution, The Journal of Physical Chemistry B 112(45) (2008) 14243-14250.
[48] H. Irving, R. Williams, 637. The stability of transition-metal complexes, Journal of the Chemical Society (Resumed) (1953) 3192-3210.
[49] S. Andersson, K. Eberhardt, C. Ekberg, J.-O. Liljenzin, M. Nilsson, G. Skarnemark, Determination of stability constants of lanthanide nitrate complex formation using a solvent extraction technique, Radiochimica Acta 94(8) (2006) 469-474.
[50] B. R. Tagirov, I. I. Diakonov, O. A. Devina, A. V. Zotov, Standard ferric-ferrous potential and stability of FeCl₂⁺ to 90° C. Thermodynamic properties of Fe_{(aq})³⁺ and ferric-chloride species, Chemical Geology 162(3-4) (2000) 193-219.
[51]S. Stepanchikova, R. Biteikina, G. Shironosova, G. Kolonin, An experimental study of hydroxo complex formation in basic and near-neutral solutions of rare-earth elements and yttrium at 25° C., Russian Geology and Geophysics 55(8) (2014) 941-944.
[52] R. P. Singh, Y. D. Yeboah, E. R. Pambid, P. Debayle, Stability constant of the calcium-citrate (3−) ion pair complex, Journal of Chemical and Engineering Data 36(1) (1991) 52-54.
[53] J. Schijf, R. H. Byrne, Speciation of yttrium and the rare earth elements in seawater: Review of a 20-year analytical journey, Chemical Geology 584 (2021) 120479.
[54] R. W. Ramette, G. Fan, Copper (II) chloride complex equilibrium constants, Inorganic Chemistry 22(22) (1983) 3323-3326.
[55] J. R. Haas, E. L. Shock, D. C. Sassani, Rare earth elements in hydrothermal systems: estimates of standard partial molal thermodynamic properties of aqueous complexes of the rare earth elements at high pressures and temperatures, Geochimica et Cosmochimica Acta 59(21) (1995) 4329-4350.
[56] W. Bourcier, H. Barnes, Ore solution chemistry; VII, Stabilities of chloride and bisulfide complexes of zinc to 350 degrees C., Economic Geology 82(7) (1987) 1839-1863.
[57] A. J. Graffeo, J. L. Bear, The formation kinetics of some lanthanide oxalate complexes, Journal of Inorganic and Nuclear Chemistry 30(6) (1968) 1577-1584.
[58] K. J. Cantrell, R. H. Byrne, Rare earth element complexation by carbonate and oxalate ions, Geochimica et Cosmochimica Acta 51(3) (1987) 597-605.
[59] S. Hubert, M. Hussonnois, R. Guillaumont, Mise en evidence de l'effet nephelauxetique dans un complexe citrique des elements de la serie 4f, Journal of Inorganic and Nuclear Chemistry 35(8) (1973) 2923-2944.
[60] A. Ohyoshi, E. Ohyoshi, H. Ono, S. Yamakawa, A study of citrate complexes of several lanthanides, Journal of Inorganic and Nuclear Chemistry 34(6) (1972) 1955-1960.
[61] A. E. Lewis, Review of metal sulphide precipitation, Hydrometallurgy 104(2) (2010) 222-234.
[62] Y. Iwata, H. Imura, N. Suzuki, Coprecipitation equilibrium of lanthanoid (III) ions with calcium oxalate, Analytical sciences 6(5) (1990) 753-756.
[63] R. D. Shannon, Revised effective ionic radii and systematic studies of interatomic distances in halides and chalcogenides, Acta crystallographica section A: crystal physics, diffraction, theoretical and general crystallography 32(5) (1976) 751-767.
[64] D. R. Lide, CRC handbook of chemistry and physics, CRC press 2004.
[65] A. Verma, R. Kore, D. R. Corbin, M. B. Shiflett, Metal recovery using oxalate chemistry: a technical review, Industrial & Engineering Chemistry Research 58(34) (2019) 15381-15393.
[66] R. Banerjee, S. Chakladar, A. Mohanty, S. Chakravarty, S. K. Chattopadhyay, M. Jha, Review on the environment friendly leaching of rare earth elements from the secondary resources using organic acids, Geosystem Engineering 25(3-4) (2022) 95-115.
[67] M. K. Jha, A. Kumari, R. Panda, J. R. Kumar, K. Yoo, J. Y. Lee, Review on hydrometallurgical recovery of rare earth metals, Hydrometallurgy 165 (2016) 2-26.
[68] J. Mustafa, A.-H. M. Aya, A. H. Al-Marzouqi, M. H. El-Naas, Simultaneous treatment of reject brine and capture of carbon dioxide: A comprehensive review, Desalination 483 (2020) 114386.
[69] E. C. La Plante, I. Mehdipour, I. Shortt, K. Yang, D. Simonetti, M. Bauchy, G. N. Sant, Controls on CO2 mineralization using natural and industrial alkaline solids under ambient conditions, ACS Sustainable Chemistry & Engineering 9(32) (2021) 10727-10739.
[70] U. S. E. P. Agency, Energy Recovery from the Combustion of Municipal Solid Waste (MSW), in: U. S. E. P. Agency (Ed.) 2023.
[71]E. León-Venegas, L. F. Vilches-Arenas, C. Fernández-Baco, F. Arroyo-Torralvo, Potential for water and metal recovery from acid mine drainage by combining hybrid membrane processes with selective metal precipitation, Resources, Conservation and Recycling 188 (2023) 106629.
[72]C. Lallemand, J. P. Ambrosi, D. Borschneck, B. Angeletti, P. Chaurand, A. Campos, M. Desmau, T. Fehlauer, M. Auffan, J. Labille, Potential of ligand-promoted dissolution at mild pH for the selective recovery of rare earth elements in bauxite residues, ACS Sustainable Chemistry & Engineering 10(21) (2022) 6942-6951.
[73] A. Kumari, N. S. Randhawa, S. K. Sahu, Electrochemical treatment of spent NdFeB magnet in organic acid for recovery of rare earths and other metal values, Journal of Cleaner Production 309 (2021) 127393.
[74] H. Geng, F. Wang, C. Yan, Z. Tian, H. Chen, B. Zhou, R. Yuan, J. Yao, Leaching behavior of metals from iron tailings under varying pH and low-molecular-weight organic acids, Journal of Hazardous Materials 383 (2020) 121136.
[75] H. Tang, W. Shuai, X. Wang, Y. Liu, Extraction of rare earth elements from a contaminated cropland soil using nitric acid, citric acid, and EDTA, Environ Technol 38(16) (2017) 1980-1986.
[76] B. Ji, Q. Li, W. Zhang, Leaching recovery of rare earth elements from the calcination product of a coal coarse refuse using organic acids, Journal of Rare Earths 40(2) (2022) 318-327.

What is claimed:

1. A method for enhancing metal recovery and/or processing from a waste source, the method comprising:
receiving a pre-concentrated feedstock, wherein the pre-concentrated feedstock comprises a leachate of a waste material contacted with a chelating agent that has be subjected to a eutectic freeze crystallization (EFC) process; and
selectively removing one or more target metals from the pre-concentrated feedstock by contacting the pre-concentrated feedstock with a precipitation agent to form a solid precipitate comprising at least one of the one or more target metal, and separating the solid precipitate from the pre-concentrated feedstock.

2. The method of claim 1, wherein the waste source comprises coal fly ash (CFA), municipal solid waste incineration ash (MSWIA), industrial solid waste incineration ash, or a combination thereof.

3. The method of claim 1, wherein selectively recovering the one or more target metals from the pre-concentrated feedstock comprises a sulfide precipitation, an alkaline precipitation, and/or an oxalate precipitation.

4. The method of claim 1, further comprising performing sequential precipitations using a plurality of precipitation agents to selectively remove a plurality of target metals.

5. The method of claim 4, further comprising:
predicting, via thermodynamic modeling, interactions between the plurality of target metals, the plurality of precipitation agents, and/or the chelating agent, to determine parameters of the sequential precipitations to optimize metal recovery.

6. The method of claim 1, wherein one or more target metals comprise a rare earth element (REE).

7. The method of claim 1, wherein a concentration factor of the one or more target metals in the pre-concentrated feedstock is 5.0 or more.

8. The method of claim 1, wherein an overall recovery of the one or more target metals is 75% or more.

9. The method of claim 1, wherein an enrichment factor of the one or more target metals compared to the waste material is 2.5 or more.

10. The method of claim 1, wherein the chelating agent comprises citric acid or a salt thereof.

11. The method of claim 1, further comprising subjecting a residual stream of the pre-concentrated feedstock following removal of the one or more target metals to a post-treatment step to process undesired metal materials.

12. A method for enhancing metal recovery and/or processing from a waste source, the method comprising:
contacting a waste source containing a plurality of target metals with a chelating agent to form a leachate;
subjecting the leachate to a eutectic freeze crystallization (EFC) process to concentrate the plurality of target metals in a concentrated feedstock;
contacting the concentrated feedstock with a sulfide precipitation agent to selectively form a first precipitate comprising an insoluble metal-sulfide complex, and a residual mixture;
separating the first precipitate from the residual mixture;
contacting the residual mixture with an alkaline precipitation agent to selectively form a second precipitate comprising an insoluble metal-hydroxide, and a second residual mixture;
separating the second precipitate from the second residual mixture;
contacting the second residual mixture with an oxalate precipitation agent to selectively form a third precipitate comprising an insoluble metal-oxalate complex, and a third residual mixture; and
separating the third precipitate from the third residual mixture.

13. A system for enhancing metal recovery and/or processing from a waste source, the system comprising:
a preprocessing unit configured to receive a waste ash source and a chelating agent to thereby form a leachate comprising one or more target metals, and wherein the preprocessing unit is configured to form a concentrated filtrate via a eutectic freeze crystallization (EFC) process; and
a metal separation unit configured to receive the concentrated filtrate and a precipitation agent, wherein, when contacted with the concentrated filtrate under conditions effective, the precipitation agent selectively forms a solid precipitate comprising an amount of the one or more target metals.

14. The system of claim 13, wherein the metal separation unit comprises:
a first precipitation unit configured to receive the concentrated filtrate and a first precipitation agent and to selectively form a first precipitate comprising an insoluble metal-sulfide complex, and a residual mixture, and to separate the first precipitate from the residual mixture;
a second precipitation unit configured to receive the residual mixture and an alkaline precipitation agent to selectively form a second precipitate comprising an insoluble metal-hydroxide, and a second residual mixture, and to separate the second precipitate from the second residual mixture; and
a third precipitation unit configured to receive the second residual mixture and an oxalate precipitation agent to selectively form a third precipitate comprising an insoluble metal-oxalate complex, and a third residual mixture; and to separate the third precipitate from the third residual mixture.

15. The system of claim 13, wherein the chelating agent comprises citric acid or a salt thereof.

16. The system of claim 13, wherein the waste source comprises coal fly ash (CFA), municipal solid waste incineration ash (MSWIA), industrial solid waste incineration ash, or a combination thereof.

17. The system of claim 13, wherein the one or more target metals comprises a rare earth element (REE).

18. The system of claim 13, wherein a concentration factor of the plurality of target metals in the concentrated feedstock is 5.0 or more.

19. The system of claim 13, wherein an overall recovery of the one or more target metals is 75% or more.

20. The system of claim 13, wherein an enrichment factor of the one or more target metals compared to the waste source is 2.5 or more.
